(19) United States
(12) Patent Application Publication
(10) Pub. No.: US 2015/0133023 A1
(43) Pub. Date: May 14, 2015

(54) SYSTEM AND METHOD FOR STORY ASSEMBLY

(71) Applicant: HALLMARK CARDS, INCORPORATED, KANSAS CITY, MO (US)

(72) Inventors: DAVID LEWIS, OVERLAND PARK, KS (US); CHRIS SHIELDS, KANSAS CITY, MO (US); BROOKE WARDEN, LEE'S SUMMIT, MO (US); THOMAS G. BRANTMAN, FAIRWAY, KS (US)

(21) Appl. No.: 14/538,499

(22) Filed: Nov. 11, 2014

Related U.S. Application Data
(60) Provisional application No. 61/903,342, filed on Nov. 12, 2013.

(51) Int. Cl. G09B 19/00; A63H 33/26

(52) U.S. Cl. CPC G09B 19/00; A63H 33/26
USPC 446/91

(57) ABSTRACT

Systems, methods, and devices are provided for assembling a story, which then may be played for a user, such as a child. In particular, an embodiment of the invention is directed to an audio or audio-visual story-telling system with functionality for seamlessly creating an entertaining, “customized” audio (or audio-visual) story for a user, using a variety of subject matter chosen by the user. In some embodiments, the system, which may be embodied as a child's toy, allows the user, such as a child, to select the subjects, themes, or other attributes of a story by arranging visual cues with images (including video or animated images) thereon to make up the parts of the story. Once selected or arranged, the user pushes play and the toy reads or plays a custom story to the user that includes their selected subjects and themes, in an embodiment.

### CROSS-REFERENCE TO RELATED APPLICATIONS

This application claims the benefit of U.S. Provisional Application No. 61/903,342, titled “System and Method for Story Assembly,” filed Nov. 12, 2013, which is hereby expressly incorporated by reference in its entirety.

### STATEMENT REGARDING FEDERALLY SPONSORED RESEARCH OR DEVELOPMENT

Not applicable.

### BRIEF SUMMARY OF THE INVENTION

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter.

In brief and at a high level, this disclosure describes, among other things, systems and methods for assembling a story, which then may be played for a user, such as a child. In particular, an embodiment of the invention is directed to an audio or audio-visual story-telling system with functionality for seamlessly creating an entertaining, “customized” audio (or audio-visual) story for a user, using a variety of subject matter chosen by the user. In some embodiments, the system, which may be embodied as a child's toy, allows the user, such as a child, to select the subjects, themes, or other attributes of a story by arranging visual cues with images (including video or animated images) thereon to make up the parts of the story. In some embodiments, the visual cues can take the form of blocks, pucks, disks, icons, cards, or other physical or virtual “components” which can be used for specifying themes, subjects, characters, plots, roles, or other story attributes or elements. Once selected or arranged, the user pushes play and the toy reads or plays a custom story to the user that includes their selected subjects and themes, in an embodiment.

In one embodiment of the present invention, a method for assembling a story is provided. The method uses the information specified by the user (such as an arrangement of blocks or pucks identifying story elements or attributes provided by a child) to assemble a story in a seamless manner. The method further includes assembling the story such that segments of the story (such as pre-recorded sound or video clips) corresponding to the user-provided information are incorporated in an apparently seamless manner. In particular, in one embodiment, the interaction of the various story elements corresponding to the information specified by the user (such as the arrangement of blocks or pucks identifying story elements or attributes provided by a child) is consistent such that sound effects, pronouns, narration and other components of the story appropriately reference characters, plot lines, settings, or other story features. Thus the assembled story, though assembled based on the user-provided information, seems as though it were a continuous story, and not pieced together from separate clips.

### BRIEF DESCRIPTION OF THE DRAWINGS

Illustrative embodiments of the invention are described in detail below with reference to the attached drawing figures, and wherein:

FIGS. 1A-1D illustratively depict one example embodiment of a story-assembler device, in accordance with an embodiment of the present invention;

FIG. 1E depicts an illustrative representation showing logical connections among components of an example story assembler device; in accordance with an embodiment of the present invention;

FIGS. 2A-2D depict block and memory-cartridge components for one example embodiment of a story-assembler device, in accordance with an embodiment of the present invention.

FIGS. 3A-3F depict a series of illustrations showing one example of a user using an embodiment of a story assembler for creating and playing back a story, in accordance with an embodiment of the present invention;

FIG. 4 is a flow diagram of a method for assembling a story in accordance with an embodiment of the invention;

FIG. 5 illustratively depicts an embodiment of a stories expansion-pack for use by an embodiment of a story assembler for creating and playing back a story, in accordance with embodiments of the present invention;

FIGS. 6A-6C depict an illustrative representation of a portion of a story skeleton with example story-segments for assembling a story about “Fixing Something Broken”, in accordance with an embodiment of the present invention;

FIGS. 7A-7C depict an illustrative representation of a portion of a story skeleton with example story-segments for assembling a story about “Sidekick Saves the Day”, in accordance with an embodiment of the present invention;

FIGS. 8A-8H depict an illustrative representation of a portion of a story skeleton with example story-segments for assembling a story about “Eating Contest”, in accordance with an embodiment of the present invention;

FIGS. 9A-9H depict an illustrative representation of a portion of a story skeleton with example story-segments for assembling a story about “Finding Something Lost”, in accordance with an embodiment of the present invention;

FIGS. 10A-10C depict an illustrative representations of a story skeleton or structure comprising a series of one or more “slots” for associating with story segments.

FIGS. 11A-11D illustratively depict one example of a story-assembler including a tablet computing device running an app and block-pucks, in accordance with embodiments of the present invention;

FIGS. 12A-12B depict a series of illustrations showing one example of using the embodiment of the story-assembler device of FIGS. 11A-11D, for assembling a story, in accordance with embodiments of the present invention;

FIG. 13 illustratively depicts another example of a story-assembler including a tablet computing device and blocks embodied as toy characters (e.g., plush or stuffed animals), in accordance with embodiments of the present invention;

FIG. 14 illustratively depicts an example of a story-assembler including a tablet computing device wherein user-input (such as a video clip of the user) is received for use as a story segment, in accordance with embodiments of the present invention; and

FIGS. 15-18 illustratively depict example embodiments story-assembler devices in accordance with embodiments of the present invention.

### DETAILED DESCRIPTION OF THE INVENTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

As one skilled in the art will appreciate, embodiments of our invention may be embodied as, among other things: a method, system, or set of instructions embodied on one or more computer-readable media. Accordingly, the embodiments may take the form of a hardware embodiment, a software embodiment, or an embodiment combining software and hardware. In one embodiment, the invention takes the form of a computer-program product that includes computer-usable instructions embodied on one or more computer-readable media.

Computer-readable media include any media readable by a computing device, database, a switch, and various other network devices. By way of example, and not limitation, computer-readable media comprise media implemented in any method or technology for storing information, including computer-storage media and communications media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. Computer storage media includes both volatile and nonvolatile, removable and non-removable media implemented in any method or technology for storage of information such as computer-readable instructions, data structures, program modules or other data representations. Computer storage media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, other magnetic storage devices, computer hardware storage devices, and other storage devices. These technologies can store data momentarily, temporarily, or permanently.

Embodiments of the invention are directed to methods, systems, and computer-readable media for assembling a story, such as a child's bedtime story, which then may be played back to the user, such as a child. In particular and at a high level, an embodiment of the invention is directed to an audio or audio-visual story-telling system with functionality for seamlessly creating an entertaining, “customized” audio (or audio-visual) story for a user, using a variety of subject matter chosen by the user. In some embodiments, the system receives story information cues from a user, such as a child. For example only and not by limitation the received information could comprise story subjects, themes, plots, characters, adversaries, props, story elements or other attributes of a story. In some embodiments, information in the form of audio, video, or text information is also received from the user and used to further customize the assembled story. Based on the received information, an embodiment of the story assembler device determines appropriate story segments and logically assembles the segments into a story.

In some embodiments, the story information cues are provided by way of visual cues specified (or provided) by the user. For example only and not as a limitation, such visual cues can take the form of blocks, pucks, disks, icons, cards, or other physical or virtual objects which can be used for specifying themes, subjects, characters, plots, roles, or other story attributes or elements. Thus in one example embodiment, a user selects or arranges one or more blocks, wherein the face of each block has a visual cue (such as an image or word) thereon, and wherein each block corresponds to an element of the story, such as one of a main character, sidekick, adversary, plot, setting, theme, or other story attribute. (Thus a 6-sided block for a main character story element might have 6 different main characters.) In an embodiment, once selected or arranged, a story is assembled based on the information cues provided, the story including the themes, subjects, characters, plots, roles, or other story attributes or elements selected by the user. When the user pushes a play button, the story assembler reads or plays the custom story to the user, in an embodiment.

A further aspect of some embodiments of the story assembler is that the story elements selected by the user (e.g., the subjects, themes, characters, or other story attributes, which may be provided by way of the user's selecting and/or arranging of blocks with visual cues) do not represent merely “fill-in-the-blanks” for the story structure. Rather, these user-selections may impact the story in a variety of ways, such as the connecting phrases between story segments, the selection of pronouns, the sound effects or background music, and even amplifying quotes or catch-phrases from the characters in the story. Thus the assembled (or “rendered”) story is consistent (appears seamless) based on the specific user-selections or user-provided information.

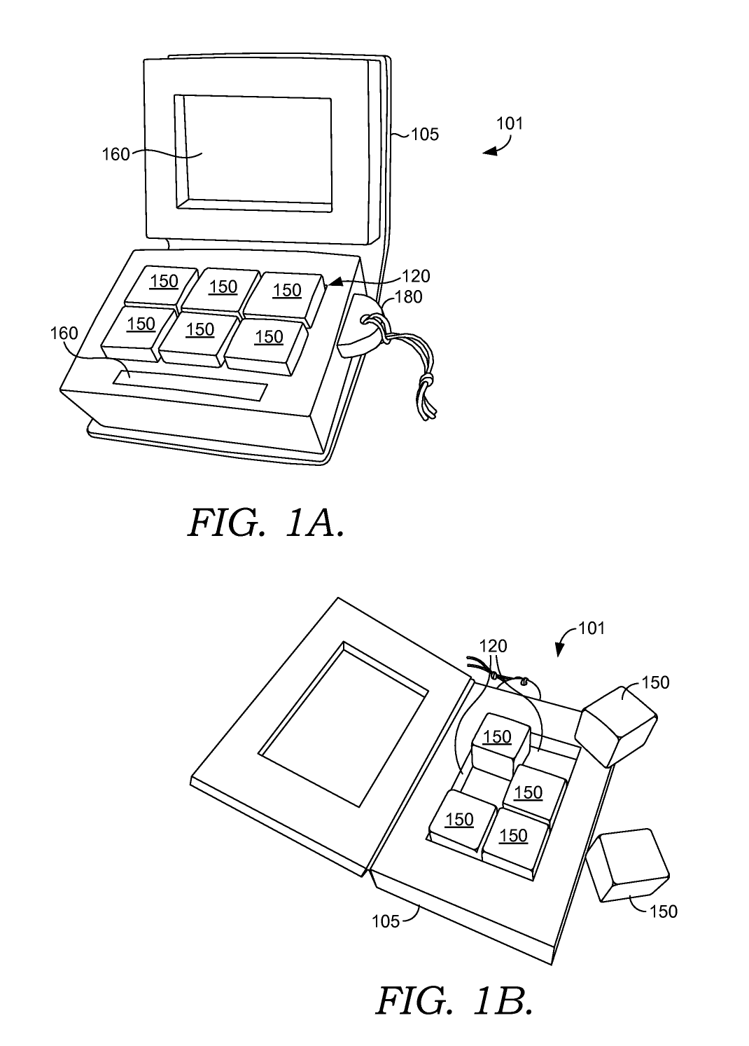

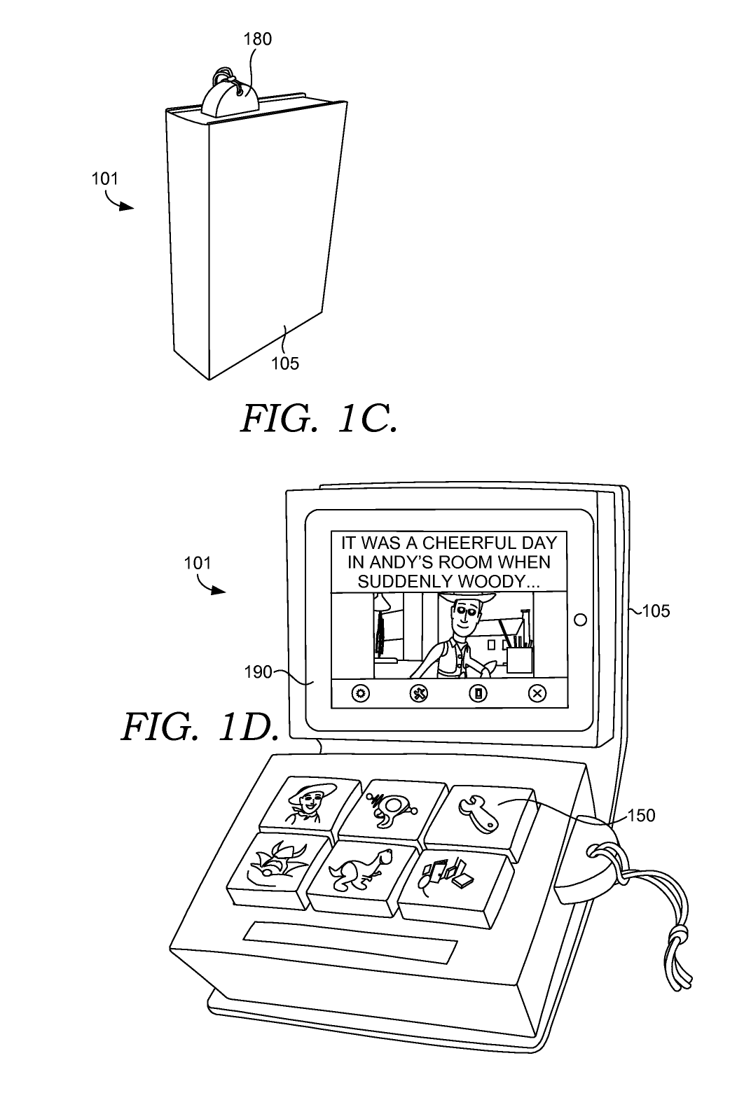

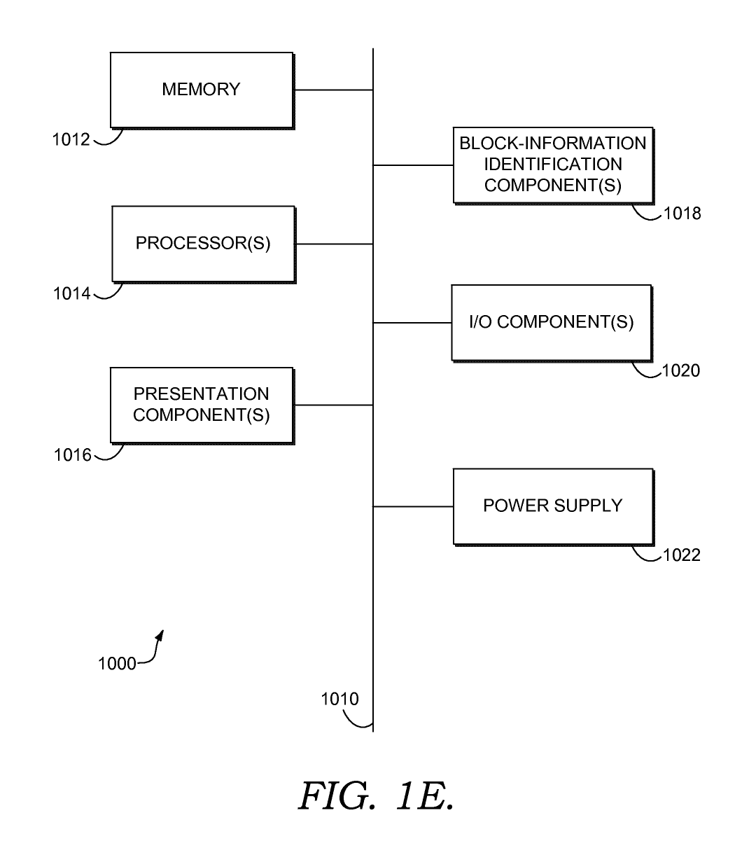

As used herein the term “story block” or “block,” in the context of the story assembler, refers to any physical or virtual “object” or component which can be used to specify or represent a story element such as character(s), plot(s), setting(s), object(s) or prop(s), event(s), user or character interaction(s), activity, or similar element of a story. A “block” may be embodied as physical or virtual object such as for example only and not by way of limitation, a six-sided cube, puck, disk, card(s), token, or configurable-object, or object which can be used to designate a specific story element (e.g., main character). Various example embodiments of “blocks” are illustratively provided in connection to FIGS. 1B, 2A-2D, 5, 11A-11B, 13, 15-18.

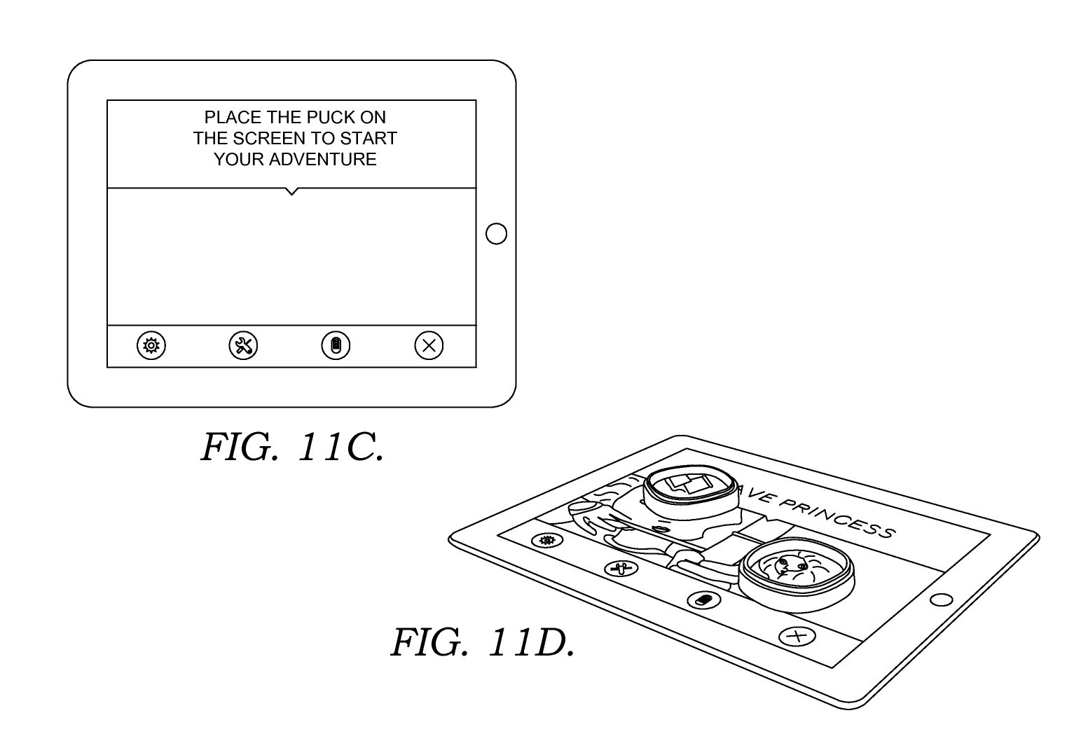

With reference to FIGS. 1A-1D, one example embodiment of a story assembler device is provided and referred to generally herein as story assembler device 101. The example embodiment of story assembler device 101 shown in FIGS. 1A-1D is embodied to resemble a book, such as shown in FIG. 1C. It is contemplated that embodiments of our story assembler device may take other forms, some of which are provided and discussed in connection to FIGS. 11C-18.

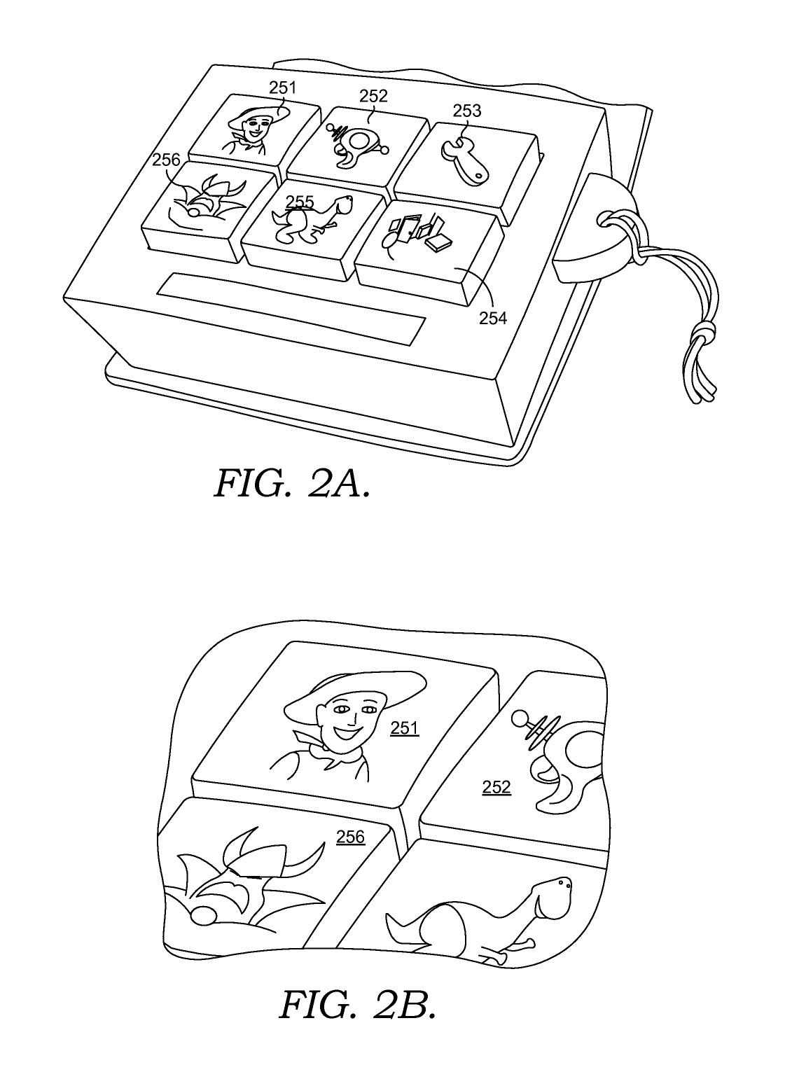

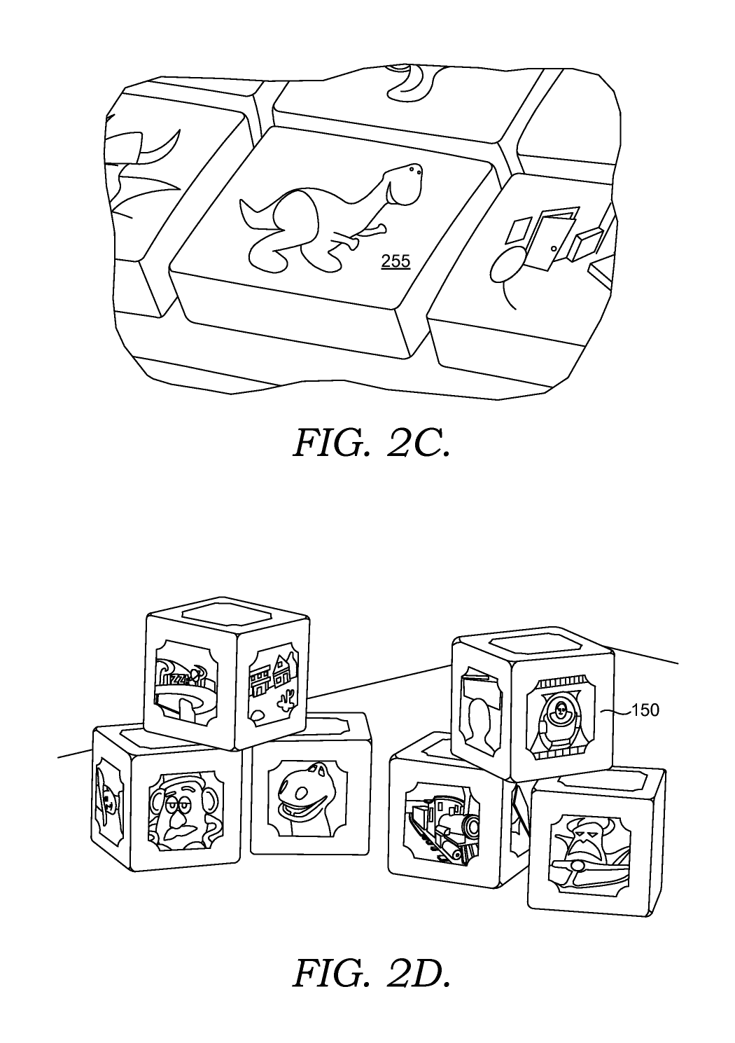

Assembler device 101 comprises a physical housing 105, which holds together or protects various components of assembler device 101. Assembler device 101 also comprises one or more blocks 150 usable for specifying story elements (e.g., main character, plot, setting, theme, sidekick, adversary, objects or props, or other story attributes) and are further discussed in connection to FIGS. 2A-2D. Assembler device also comprises block-receptacle area 120, which may take the form of a partial enclosure capable of holding one or more blocks 150 (as shown), a surface on which one or more blocks may be placed, or any physical or virtual location for ‘holding” a position or arrangement of one or more blocks. It is further contemplated that some embodiments of the story assembler device do not include a block receptacle; blocks 150 may be arranged or specified instead on a table, floor or other surface (including other blocks), or virtually specified or provided via a user interface of a story assembler. In some of these embodiments, the story assembler device may be used in proximity to the blocks.

Assembler device 101 further comprises a button 160 or other suitable user-interface component for which a user may control features of assembler 101, such as playing back the story. For example, after arranging blocks 150, a child presses button 160 and hears the story. In some embodiments, button 160 may take the form of a graphical user interface, such as a touch screen display, a mouse and display, or sensor for receiving hand/motion gesture or voice-command information. Some embodiments of assembler 101 do not include button 160 and instead proceed to playback the assembled story once story-cue information has been provided (e.g., once the blocks have been selected and arranged in receptacle 120).

Some embodiments of assembler device 101 (shown in FIGS. 1A-1C) also include memory cartridge 180, which may take the form of one or more computer memory devices, which stores some computer instructions and data for assembling a story based on story information cues provided by an arrangement or selection of blocks. In some embodiments, memory cartridge 180 includes the logic and story data (e.g., story segments, audio or video clips, text, images) used for assembling and playing back a story. In some embodiments, memory cartridge 180 is a removable computer memory device, such as a solid-state or magnetic storage device, flash storage drive, USB data drive, memory token, or similar device.

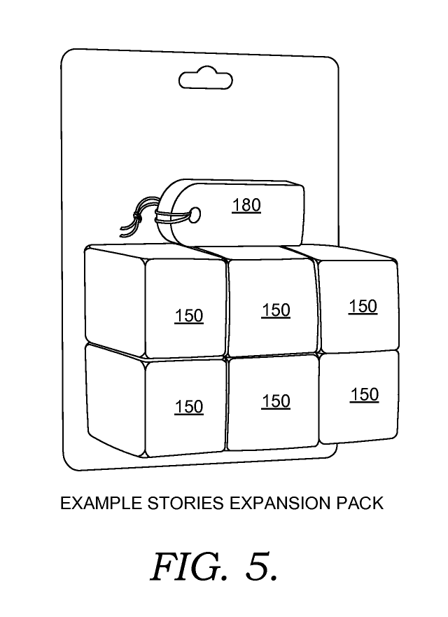

In some embodiments, the memory cartridge is associated with a set of blocks 150. For example, a set of blocks could be associated with a movie, such as Disney's Toy Story, wherein one block is for specifying a main character of the story based on a selected block-face (e.g., Woody, Buzz, etc.), one block specifies a setting, one block specifies an object or prop for the story, etc. The associated Toy Story memory cartridge 180 would thus include story segments (which could include narrations, images, text, video and/or sound effects, for example) corresponding to the characters, settings, etc. of Toy Story. It is further contemplated that sets of blocks and a memory cartridge 180 may be bundled and sold as story expansion sets, such as illustratively shown in FIG. 5. For example, one expansion set could be based on the movie Disney's Cars, and include blocks with characters, settings, plots, and other story elements from Cars and a memory cartridge 180 with story segments from Cars.

In some embodiments of assembler 101, story logic and data are stored on the story assembler device 101, rather than on a removable memory cartridge 180, and memory cartridge 180 takes the form of a card, token, or other physical or virtual device (such as a drop-down menu or similar user-interface) usable by the story assembler for referencing a particular set of computer information for assembling a story. For example, instead of memory cartridge 180, a user may select a “story” by browsing a user interface and making a selection such as via clicking on an icon or menu, providing a code, inserting a coded card or token, or scanning in a printed barcode or image. In such embodiments, story assembler 101 receives story logic and data by accessing memory (including online, downloading, or cloud-based memory), which corresponds to the user selection or provided code, token, barcode, etc.

Some embodiments of assembler 101 further include a graphical user-interface 190, which may take the form of an electronic or computer display. In some embodiments, the assembled story is played back using interface 190, and may include audio, video, or graphics that are presented to the user via interface 190. In an embodiment, graphical user interface 190 comprises a tablet computing device. For example, FIG. 1D provides an illustrative example embodiment of a story assembler wherein housing 105 includes a sleeve for holding a tablet computing device (such as an Apple® iPad®). In this embodiment, a memory cartridge is not needed, as story logic and data may be specified via the touch interface of the tablet (for example, by browsing collections of story sets).

Turning now to FIG. 1E, an exemplary operating environment showing logical connections among components of one embodiment of a story assembler device is shown and designated generally as computing environment 1000. Computing environment 1000 is but one example of a suitable computing environment and is not intended to suggest any limitation as to the scope of use or functionality of embodiments of the present invention. Neither should the computing environment 1000 be interpreted as having any dependency or requirement relating to any one or combination of components illustrated.

Some embodiments of the present invention may be described in the general context of computer code or machine-usable instructions, including computer-executable instructions such as program components, being executed by a computer or other machine, such as a personal data assistant or other handheld device. Generally, program components including routines, programs, objects, components, data structures, and the like refer to code that performs particular tasks, or implements particular abstract data types. Some embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1E, computing environment 1000 includes a bus 1010 that logically couples the following components: memory 1012, one or more processors 1014, one or more presentation components 1016, one or more block-information identification components 1018, I/O components 1020, and an illustrative power supply 1022. Bus 1010 represents what may be one or more buses (such as an address bus, data bus, or combination thereof). Although the various blocks of FIG. 1E are shown with lines for the sake of clarity, in reality, delineating various components is not so clear, and metaphorically, the lines would more accurately be grey and fuzzy. For example, one may consider a presentation component such as a display device to be an I/O component. Also, memory component 1012 may include memory cartridge 180 of FIGS. 1A-1C as well as other computer system memory. Also processors have memory. The inventors hereof recognize that such is the nature of the art and reiterate that the diagram of FIG. 1E is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1E and reference to “computer” or “computing device.”

Memory 1012 includes computer storage media in the form of volatile and/or nonvolatile memory. The memory may be removable, nonremovable, or a combination thereof. Exemplary hardware devices include solid-state memory, hard drives, optical-disc drives, etc. Computing environment 1000 includes one or more processors that read data from various entities such as memory 1012 or I/O components 1020. Presentation component(s) 1016 present data indications to a user or other device. Exemplary presentation components include a display device, speaker, printing component, vibrating component, etc. Illustrative I/O components include buttons, a microphone, joystick, game pad, touch interface, satellite dish, scanner, printer, wireless device, etc., and may be built in or external.

Block-information identification component(s) 1018 (“identification components 1018”) comprises hardware and/or software components for determining block-information such as by determining block identification, orientation and/or position information. In an embodiment, block-information identification component(s) 1018 may be implemented at appropriate abstraction layer(s) such as the operating system layer, application layer, hardware layer, etc., of the computing system(s). Alternatively, or in addition, the functionality of block-information identification component(s) 1018 can be performed, at least in part, by one or more hardware logic components. For example, and without limitation, illustrative types of hardware logic components that can be used include Field-programmable Gate Arrays (FPGAs), Application-Specific Integrated Circuits (ASICs), Application-Specific Standard Products (ASSPs), System-On-a-Chip systems (SOCs), Complex Programmable Logic Devices (CPLDs), etc.

By way of example and not limitation, an embodiment of block-information identification component(s) 1018 determines that a particular block 150 is in receptacle 120 and further determines the orientation of the particular block 150, such as which side of the block is the top and facing out to the user. For example, a user places the main character block into receptacle 120 such that the character Woody from Toy Story, is shown on the top side of the block, indicating that the user desires to hear a story wherein Woody is the main character. (Thus, story cue information includes Woody as main character.)

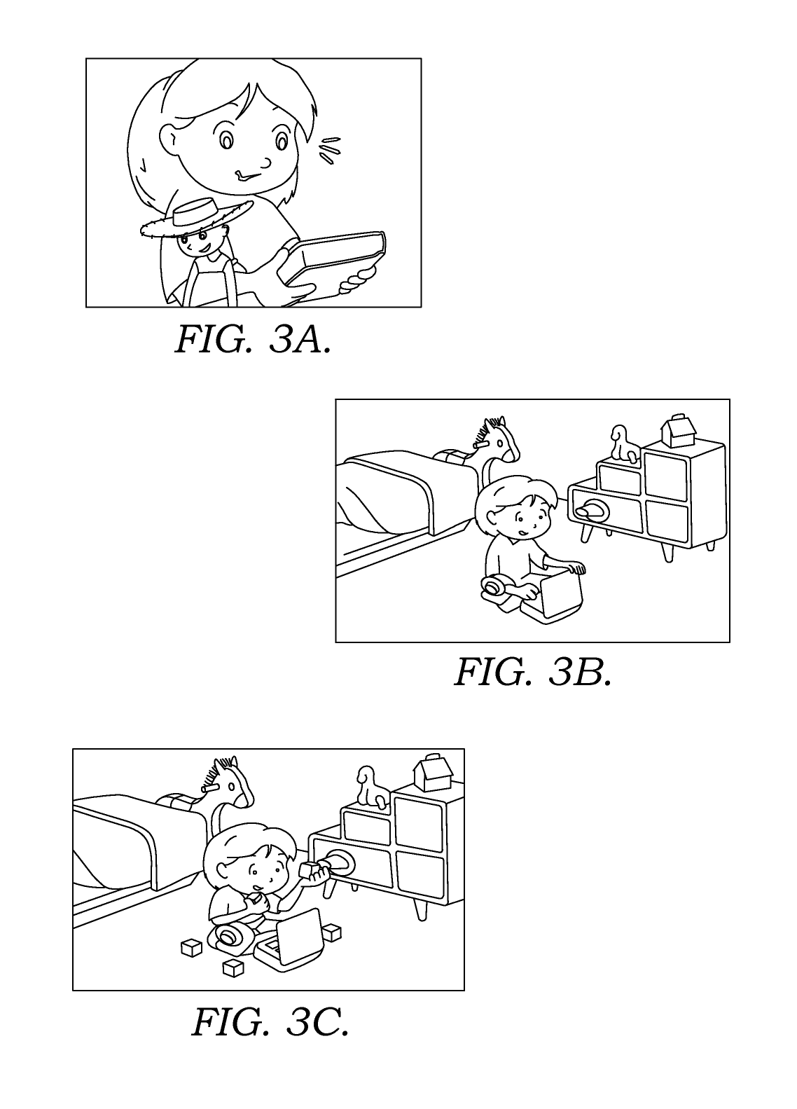

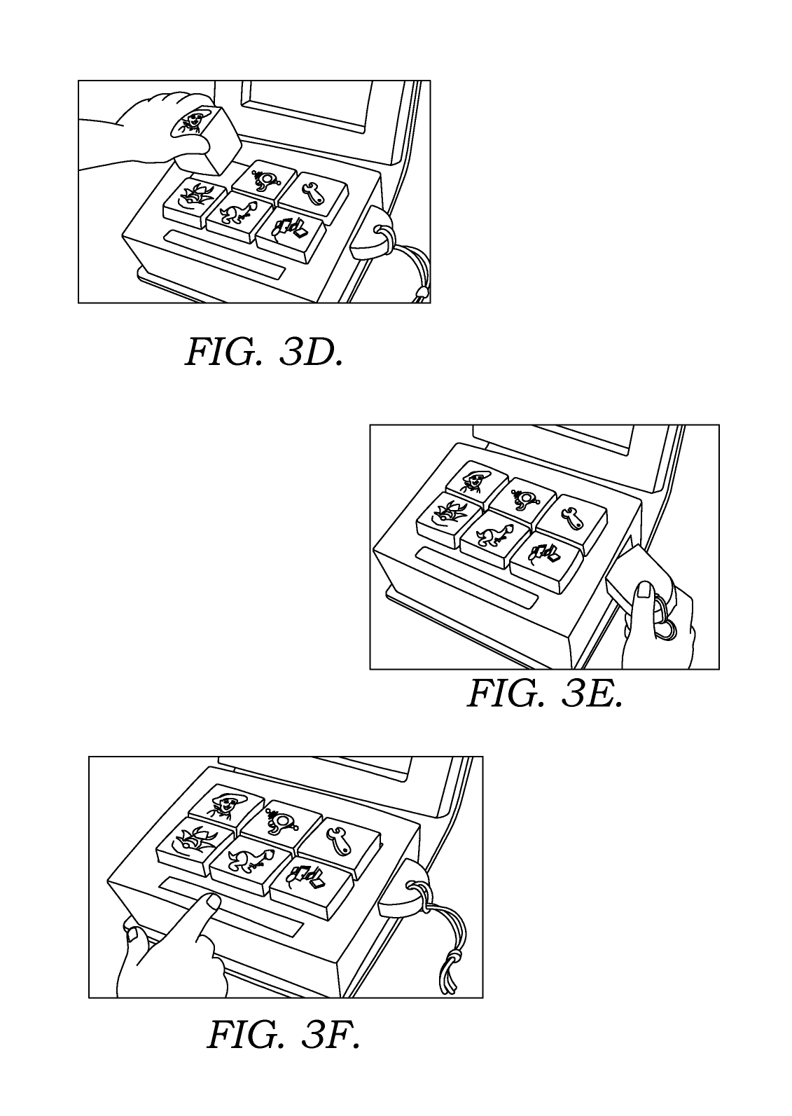

In this manner, block information (including orientation information that can be used to determine that the Woody side is the top surface of the main character block positioned in receptacle 120) is determined and provided via bus 1010 to other components of story assembler 101. Continuing this example, story assembler 101 can determine via processor component 1014, the story cue information (Woody as main character) based on the block information determined by identification components 1018, thereby enabling the story cue information to be used for assembling a story. An example of using blocks for story assembly is discussed in connection to FIGS. 3A-3F. In some embodiments, story cue information is associated with block identification information, such as by way of a relational database, table, record, or other database, which may be stored on memory cartridge 180 or on memory 1012 accessible by assembler 101. In this way, block information received by processor component 1014 may be used for looking-up or accessing story cue information associated with the received block information.

In an embodiment, block information comprises information usable for identifying a particular block, which can be used to differentiate one block, such as a main character block type, from another block type, such as a settings block type, or a plot block type. In one embodiment, this takes the form of an identifier, which may be either common among block types for each story set (For example, the main characters block for the Toy Story block set has the same identifier as the main characters block for the Cars block set. By sharing block identifiers in this manner, the number of identifiers needed is reduced.) or unique to each block. For example, the identifier for the main characters block for Toy Story is unique and not shared by the main characters block for Cars. This requires more identifiers, but enables embodiments of story assembler 101 that may assemble stories using characters (and corresponding story segments) from different story sets, such as a story about Woody in the setting from Cars. The identifier may take the form of an identifying image, pattern, color, or code, printed on, embedded in, or associated with the block, such as via camera or RFID, a weight, size, shape, or physical arrangement of holes, depressions, protrusions, bumps, block-edges, 3D surface pattern, materials, or any features that can be used to distinguish one block from another block. In embodiments of blocks as pucks or disks usable on a tablet computing device, patterns of raised bumps or conductive pads may be used as an identifier of a particular block type, such as main character or setting, and further to identify a specific block attribute such as Princess Merida from the Disney movie Brave, as shown in FIGS. 11A-D and 12A-B. In some embodiment, block information further comprises orientation information, such as which side of the block is facing up. And in some embodiments, the block information further comprises position information, such as the location of a block 150 in receptacle 120, the location with respect to other blocks 150, or location information in 2D or 3D space, such as relative to story assembler 101.

Embodiments of identification component 1018 may take the form of any technology usable for determining block identification, orientation, and/or position information. By way of example only and not limitation, an embodiment of component 1018 comprises one or more RFID, MFID, sensors such as optical (e.g., bar code reader or camera), electrical, magnetic chemical, or mechanical/physical sensors. In one embodiment mechanical “fingers” are used to “read” depressions and elevations to surfaces (block edges or faces) for identifying block information. In these embodiments, the “fingers” operate analogously to the way the tumblers match a key in a lock. In one embodiment, electrical resistance, capacitance, or magnetic fields are used to identify block information. In another embodiment, block location and/or orientation technology, such as gyroscopic components, communicate identification, orientation and/or position information to assembler device 101. In some embodiments, a block includes a communication component such as Bluetooth communication for communicating with assembly device 101 and/or with other blocks.

In an embodiment, block information is determined using a touch-screen enabled device, such as an iPad or tablet computer running an app, and blocks (such as pucks or disks) having patterns of raised bumps or conductive pads that are spatially arranged so as to communicate a pattern of contact points onto the touch surface. In such a way, specific blocks can be identified based on this “touch pattern.” An example of this embodiment is provided in FIGS. 11A-D and 12A-B.

In another embodiment block information is determined using an optical sensor such as a camera. For example, in the embodiment depicted in FIG. 1D, a display 190 comprises a tablet computer such as an iPad. A camera on the tablet may be used to “read” the surfaces of the blocks in order to determine the block information. Thus in the example of FIG. 1D, based on the position of the tablet (display 190) a camera can capture an image of the arranged blocks 150, and using processors 1014 of the tablet computer, can apply image-recognition technology to identify the top surface of each block (and in some embodiments, the position of the block in receptacle 120) thereby determining block information. One advantage of this embodiment is that the blocks can be “dumb.” In other words, the blocks do not require any specific electrical, magnetic, weight, codes, shape/size-differences, or other features used to distinguish the blocks. Only the image of a character (or word(s)) on the block surface is used to recognize the block face and thus determine block information.

Turning now to FIGS. 2A through 2D, examples of blocks 150 are provided in accordance with embodiments of the present invention. In an embodiment, each block represents a different element of a story (such as main character, setting, plot, or other story attribute), which is designated by an image(s) printed on the surface of the block. For example, one cube may represent an adversary in the story to be assembled, wherein each face of that cube shows a different adversary. A user selects the particular adversary to be included by placing the image of that adversary as the upward-facing image of the block, in an example. Another block may be the setting for the story, with each face of the block representing a different setting. Other blocks may represent story elements such as, by way of example and not limitation, protagonists, sidekicks, objects, goals, or story types. Continuing this example embodiment, when the blocks are placed in the receptacle 120, the face of each cube that is visible (the top surface) indicates the specific element that was chosen for the story being assembled. Based on the selection (and in some embodiments, the arrangement) of blocks inserted into the receptacle, the story assembler determines each of the story parts and assembles the parts into a story. The story can then be played back audibly (as sound) or audio-visually (as video including images with sound) using the story elements chosen by the user.

With reference to FIG. 2A, six blocks (251-256) are illustratively shown. Each of these 6 blocks has a block type and attribute corresponding to a story element such as a main character, setting, plot, object, adversary, or other story attribute to be incorporated into the assembled story. In this example, blocks 251-256 are part of the Disney Toy Story block set. Block 251 is a main character block and depicts Woody as the main character selected by the user, based on the upward facing image of Woody. Blocks 252 and 253 specify objects or props (a ray gun and wrench, respectively) that will be included in the assembled story. Block 254 is a settings block type; here the selected setting is Andy's room. Block 255 is a sidekick block type, indicating which side-kick characters are to be a part of the assembled story (here Rex the dinosaur). Finally, block 256 is an adversary block type (here the Zurg character of the Toy Story movie series). Accordingly, a story assembled based on the arrangement of blocks (as shown in FIG. 2A) would include the following story elements: Woody as the main character; Andy's room as a setting; Zurg as an adversary, Rex as a sidekick character, a wrench, and a ray gun. Additional examples of blocks are depicted in FIG. 2D.

In some embodiments, sets of blocks correspond to a set of stories centered around a particular movie, theme, or attribute, such as Toy Story or Cars. In these embodiments, each set of blocks can include a main character block (or subset of main character pucks), settings block (or subset of settings pucks), and other block types. In some embodiments, the sets of blocks may be associated with a particular memory cartridge 180, and may be color coded to indicate that the blocks are intended to be used with a particular memory cartridge. Additional sets of blocks (and in some embodiments, an accompanying memory cartridge) can be sold as expansions story sets, such as shown in FIG. 5. In tablet-computer based embodiments without a memory cartridge 180, a story-assembler app running on the tablet device can provide visual clues (colors, icons, graphics, or similar features) to match the block features for a corresponding set of blocks. (For example, in the app where a user has selected the Cars story set, the border color of the app is the same color as the blocks, thereby providing an indication to the user that blocks of the same color should be used. This is particularly useful where blocks share identifiers, to prevent the situation where a user uses the main character block from Toy Story in the Cars story set, and the assembler device interprets the selected main-character block (e.g., Woody) as a character from Cars, because the blocks share the same identifier.

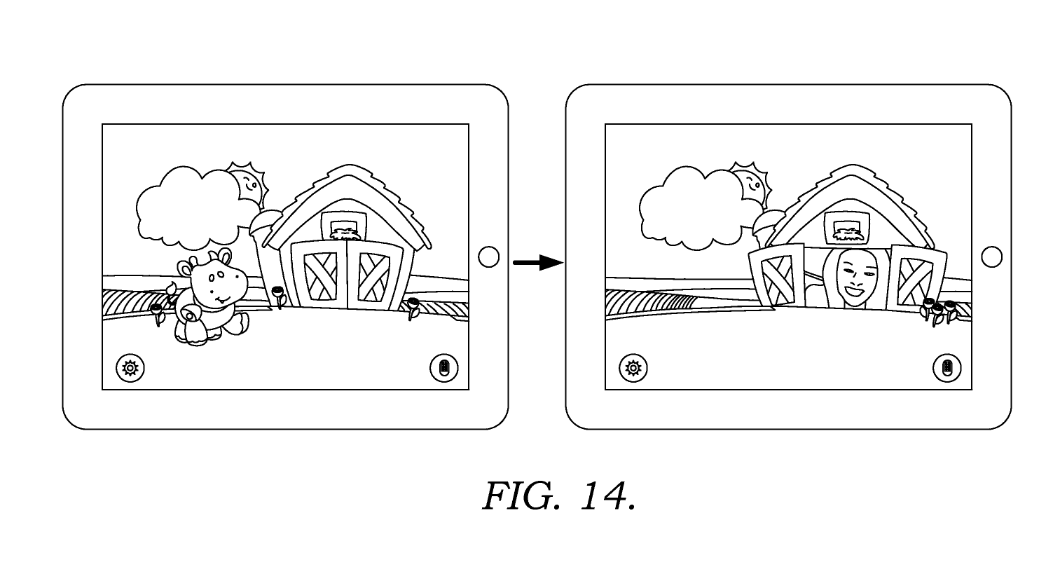

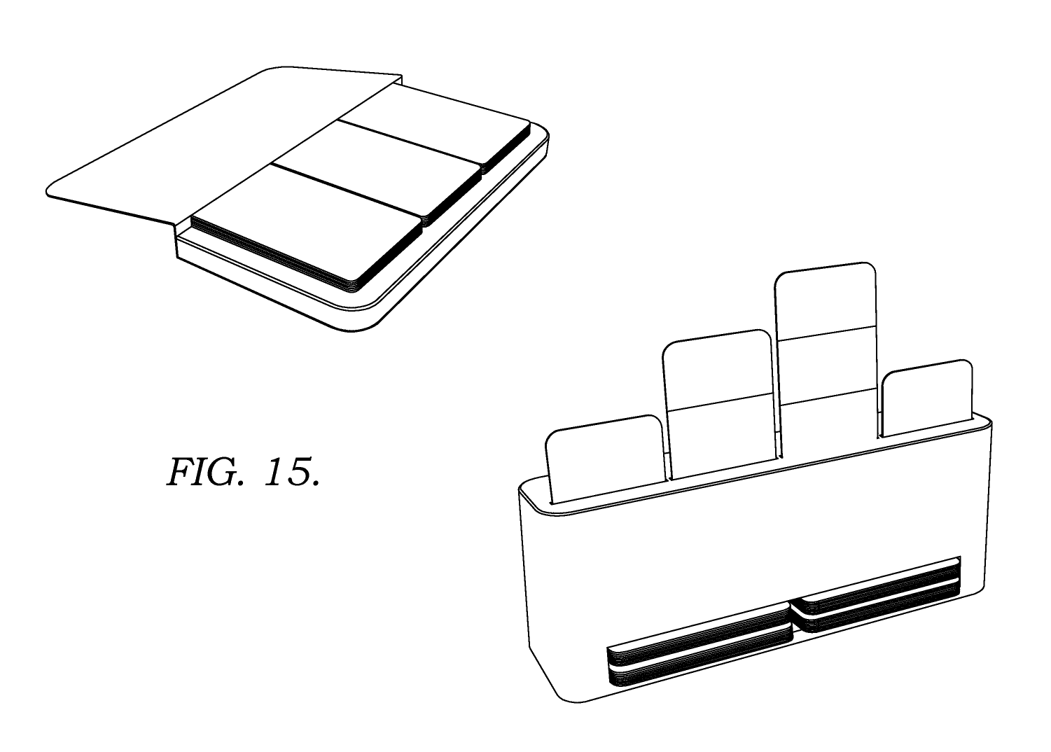

In an embodiment, blocks (or settings in tablet-based embodiments) can specify user provided content to be incorporated into the assembled story. For example, a block can be customized to read the child's name or show the child's picture, and incorporate the child into the assembled story. In an embodiment, such a feature can be facilitated by prompting the user to provide information such as making sound effects, or taking a picture. For example, in advance of assembling the story, in some embodiments, user-supplied story segments (such as sound effects, pictures or video) may be received from the user (such as via prompting) and incorporated into the story. In embodiments, this user-supplied information can be provided in advance or real-time, as the story is being played. For example, the first time a particular sound effect is played, the user is prompted to make the sound effect and the user's sound is recorded. Thereafter in the story, each time the sound is repeated, the recording of the user's sound is played. An example of a story incorporating user-supplied content is illustratively provided in FIG. 14, which shows a portion of story comprising a video clip of a user appearing behind the barn doors. In some embodiments, the video clip is recorded in advance, before the story is assembled, and in some embodiments the video clip comprises a live feed from the camera of the tablet computing device.

Turning now to FIGS. 3A-3F a series of illustrations is provided showing one example of a user using an embodiment of a story assembler for creating and playing back a “seamless” story, in accordance with embodiments of the present invention. At a high level, a user, such as a child, selects the subjects, themes or other elements of a story by arranging visual cues in the form of blocks with images thereon to make up the parts of the story. Once arranged, the child pushes play and the assembler device 101 reads a custom story to the user that includes their selected subjects, themes, and other story elements, in a manner that appears seamless or internally consistent. In this example, the assembled story is based on a Toy Story story set.

With reference to FIG. 3A-3F, a user, such as a child picks the story assembler device (FIG. 3A). In this example embodiment, the user opens the story assembler device, like opening a book (FIG. 3B). It has blocks within it, with images on each block (FIG. 3C). The user inserts a cartridge that goes with the blocks (FIG. 3E) and organizes the blocks in any order, selecting any of the six images on each block (FIG. 3D). The user then pushes a button to begin the story (FIG. 3F). The story assembler device plays back a story that includes story elements shown on the blocks selected by the user. As the story progresses and is narrated, music can play in the background, as well as sounds specific to each block image, and audio from each block character or other block element. For example, using the block configuration shown in FIG. 2A, the displayed block faces include: Woody, Ray gun, a wrench or tool, Emperor Zurg, Rex, and an image of a bed in Andy's room. In this configuration, the following story, which is provided as an example, may be assembled based on these arrangement of blocks, and recited by the story assembler:

[Music playing] “One sunshiny morning, Woody heard an odd noise coming from under the bed in Andy's room. He went to find out what it was, only to discover Rex starring at a busted up ray gun. [Sound effect from Rex about the broken ray gun.] Woody decided to help Rex repair the ray gun, and ran off to find just the right tools. But then something horrendously horrible happened! Emperor Zurg jumped out and snatched them away for some sinister scheme. [Sound effect from Emperor Zurg.] Without a moment to loose, Woody stepped forward and began a dorky dance for Zurg. [Sound effect from woody.] With Zurg sufficiently distracted, Woody grabbed the tools and raced back under the bed where Rex waited. Together they were able to fix up the ray gun until it was once again perfect play worthy.”

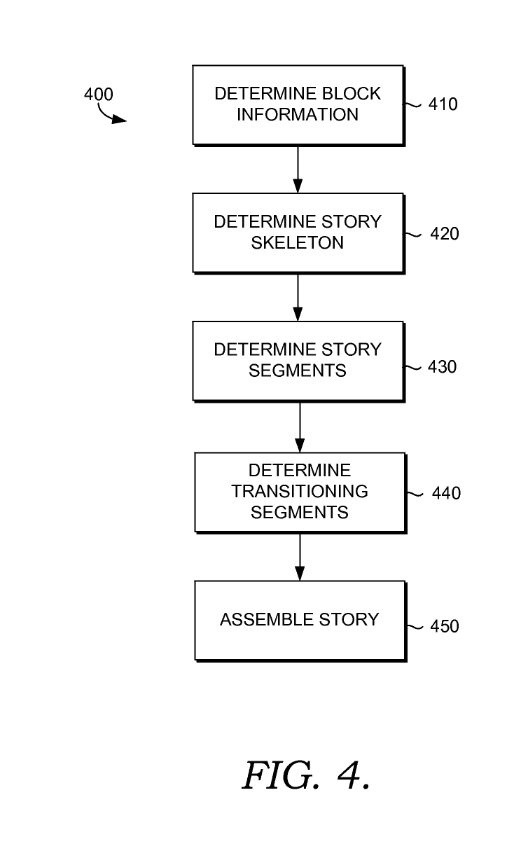

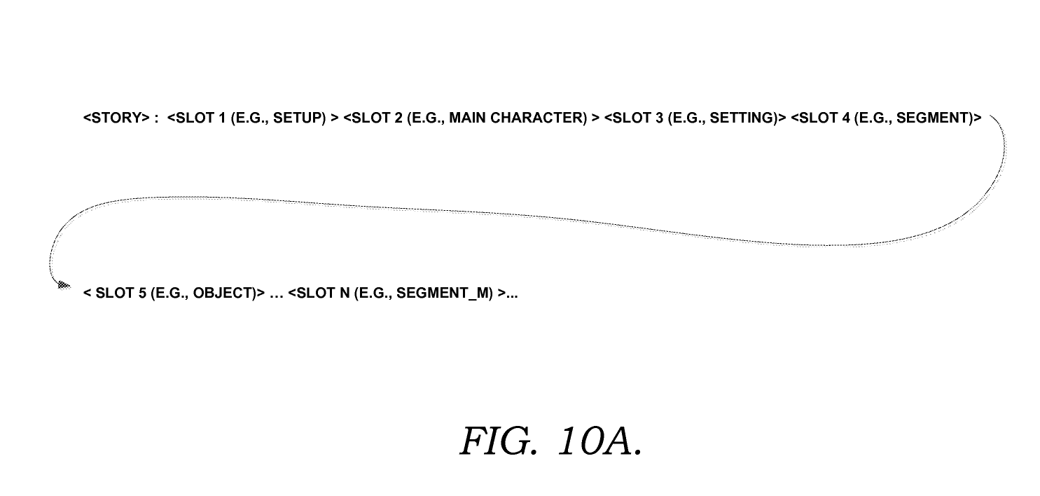

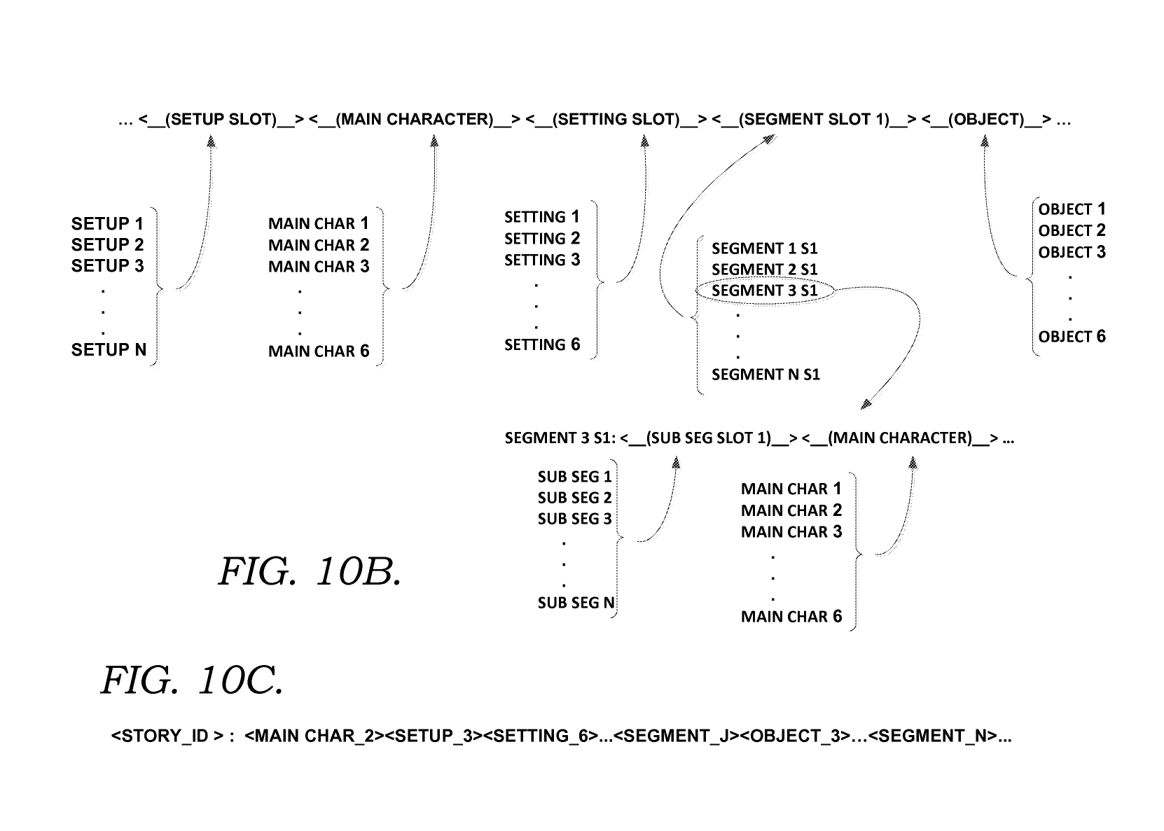

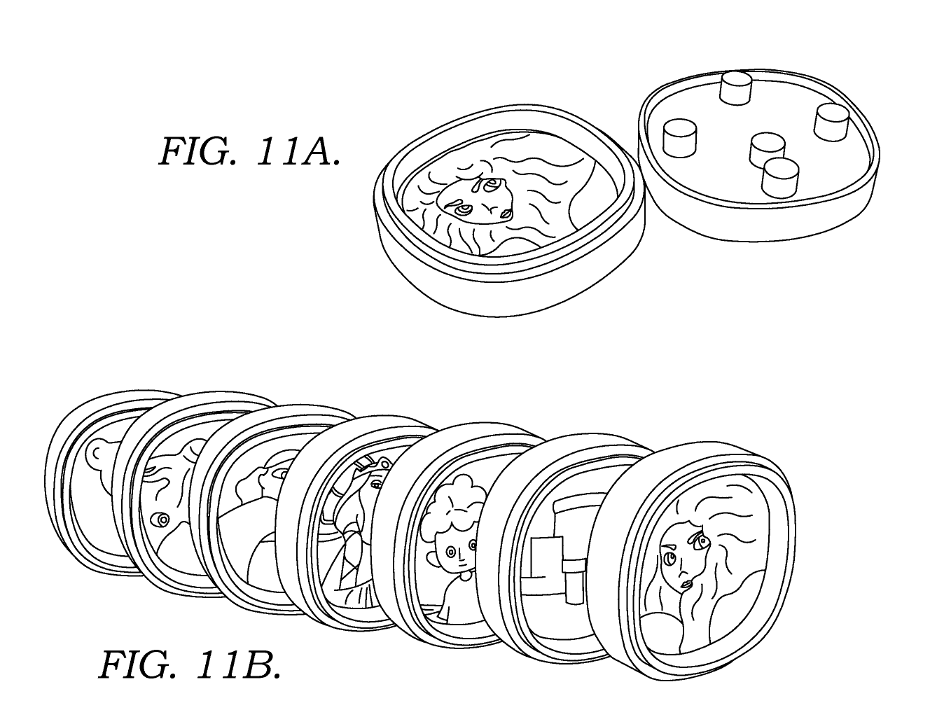

In some embodiments, as described in connection to FIGS. 4 and 10B, pieces of the story (story segments) are randomly or pseudo randomly determined. Therefore, while the same arrangement of blocks will include a story with the same story elements as specified by the block arrangement (e.g., the same main character), the resulting story may be different.

Returning to the example of FIGS. 3A-3F, the user can rearrange the blocks to have another story created. For example, suppose the user rearranges the blocks to have the following arrangement (not shown): the block faces show Lots-O' Bear, Wheezy bird, an image of a bed in Andy's room, a skateboard, Jessie, and a wrench or tool. In this reconfiguration, the following story, which is provided as an example, may be assembled based on the blocks, and recited by the story assembler:

[Music playing] “One rainy afternoon, Jessie heard an odd noise coming from under the bed in Andy's room. She went to find out what it was, only to discover Wheezy staring at a cracked up skateboard. [Sound effect from Wheezy.] Jessie decided to help Wheezy repair the skateboard and ran off to find the right tools. But then disaster struck! Lots-O' jumped out and greedily grabbed them for himself. [Sound effect from Lots-O'.] Without a moment to loose, Jessie darted out and began to spin Lots-O' round and round. [Sound effect from Jessie.] While Lots-O' was busy being dizzy, Jessie grabbed the tools and raced back under the bed where Wheezy waited. Together they were able to fix up the skateboard until it was once again totally toy-riffic!”

In embodiments, the stories are rendered (based on the configuration of the blocks) in a manner that is seamless to the listener. In other words, the connecting phrases between story segments, such as the selection of pronouns, the sound effects or background music, and amplifying quotes or catch-phrases from the characters in the story, are internally consistent, and specific to the configuration of blocks. For example, if the lead character has changed from Woody to Jessie, then pronouns are changed to be consistent. Thus, “He went to find out what it was,” becomes “She went to find out what it was,” as shown in the above examples.

Turning now to FIG. 4, a flow diagram is provided of a method 400 for assembling a story. At a step 410, block information is determined. In embodiments, block information is determined as described above in connection to FIG. 1E. Based on the determined block information, at a step 420, a skeleton story is determined. A story skeleton comprises a structure (or bones) of a story, and includes one or more logical slots or placeholders for various story segments (described below). It may also include logic or rules for determining segments to fill the slots, such as information specifying which segments (e.g., sound effects, pieces of narration including narration with pronouns, images, plot developments, text, video or audio clips, provided here for example only and not by way of limitation) are associated with each other and which are not, as well as which segments may be dependent on other segments. (For example a segment comprising a sound effect made by Woody is dependent on a segment of narration about Woody. In other words, the Woody sound effect segment would not be used but for the use of a narration segment about Woody.)

In embodiments, the story skeleton is determined based on the story elements specified by the block information determined in step 410. In some embodiments, a set of story skeletons corresponding to the block information is first determined, and then a story skeleton is randomly or pseudo-randomly determined from that set. In an embodiment, the selection process is a least used or least recently used skeleton, in order to minimize repeating story skeletons. An example story skeleton is illustratively provided and discussed in connection to FIG. 10A-10C.

At a step 430, story segments are determined. Story segments include, by way of example only and not limitation, pieces or narration (including narration with pronouns), sound effects, character expression images, plot developments, text, video or audio clips. Story segments may be assembled or logically “stitched” together to make a story. In an embodiment, based on logic specified by the story skeleton, story segments are determined. In some embodiments, story segments are also determined based on the story skeleton and block information determined at step 410. In embodiments, story segments are specified by logic in a story skeleton or logic in a database of record entries for the story elements (e.g. main characters, setting, etc.) indicated by block information. In some embodiments, the story segments are accessed from memory 1012 or memory cartridge 180. In some embodiments, a story segment is embodied as a shorter story skeleton and includes logic and slots for filling with additional story segments (as shown in the example segment 3 of FIG. 10B). In some embodiments, segments include logic indicating which segments can be used in conjunction with the segment (for example a narration segment about Woody might include logic specifying one or more Woody sound-effect segments that can be played during the narration segment or elsewhere in the story). In some embodiments, segments include logic about which segments are dependent on it. (For example, a particular narration segment about Woody may include logic specifying which transition segments to use (discussed at step 440) in order to be consistent).

At a step 440, transitioning story segments are determined. Transitioning segments include segments that connect story segments determined in step 430 in order to render the story internally consistent or “seamless” For example, where block information 410 indicates that Woody is the story element for the main character, and a narration segments, sound effects, or other story segments for Woody are determined at step 430, then at step 440, appropriate transitioning segments are determined to transition or seamlessly stitch together the segments determined in step 430. Thus for the example of Woody discussed in connection to FIGS. 3A-3F, an example transitioning segment would include: “he went to find out what it was,” the “he” referring to Woody. Whereas, in the case of story segments determined at 430 for Jessie, an appropriate transitioning segment would be “she went to find out what it was.”

At a step 450, the story is assembled. In an embodiment, the determined segments are associated or logically connected in series based on the information specified by the story skeleton and/or block information. In an embodiment, logical pointers are used in a table to indicate the order or timing of the various story segments (including sound effects and video clips) to be played back in order to create the story. In an embodiment, after arranging the blocks (or pucks on a tablet surface), the story is assembled at step 450. The assembled story may be played back for the user, such as upon the user pressing button 160.

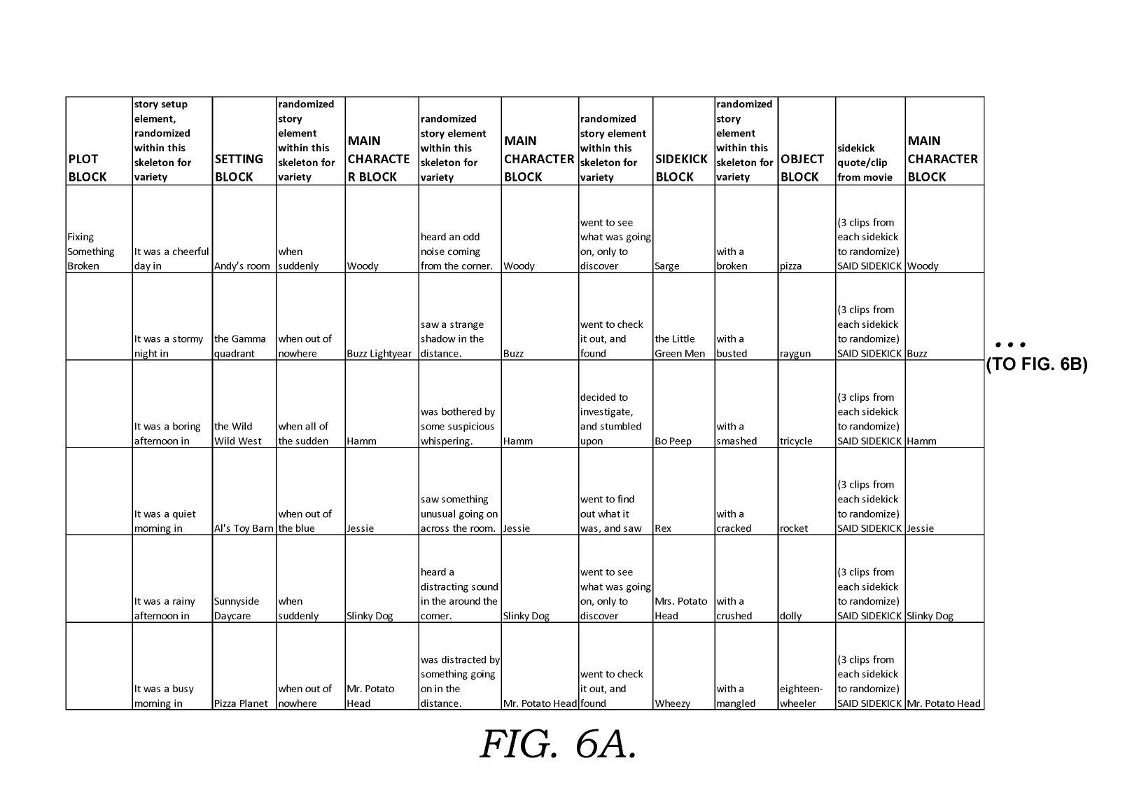

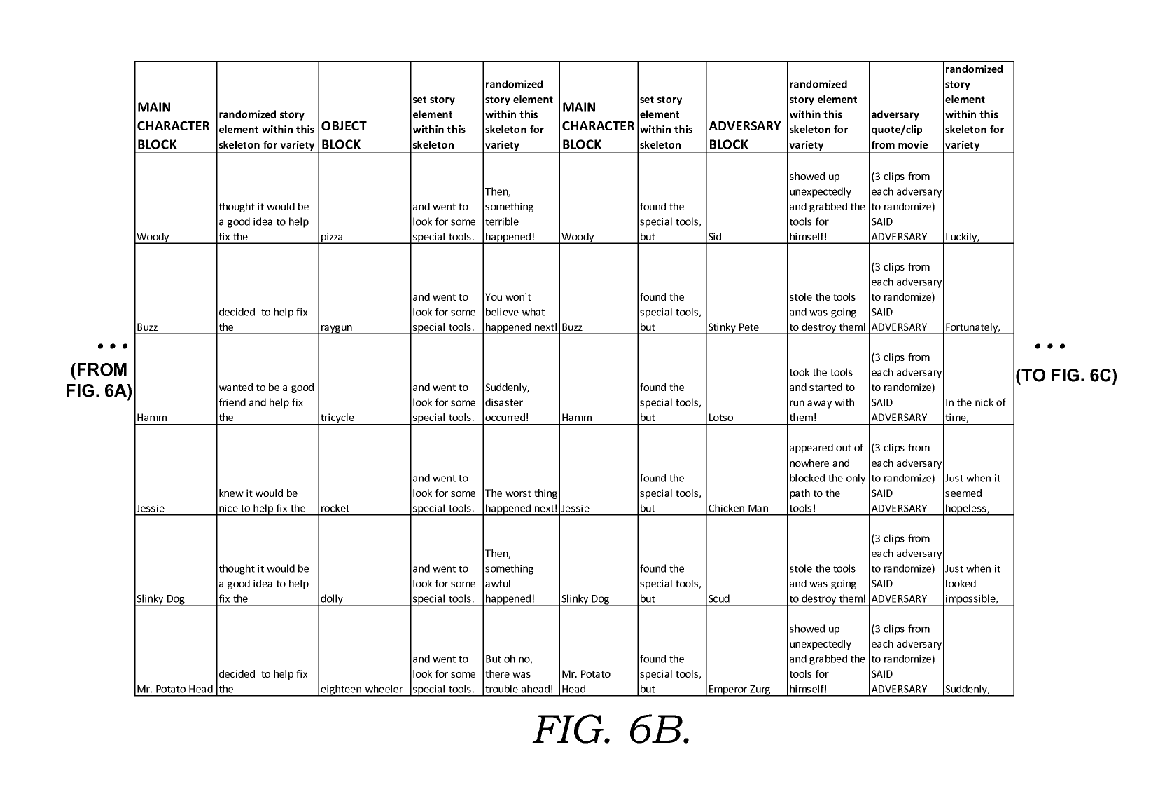

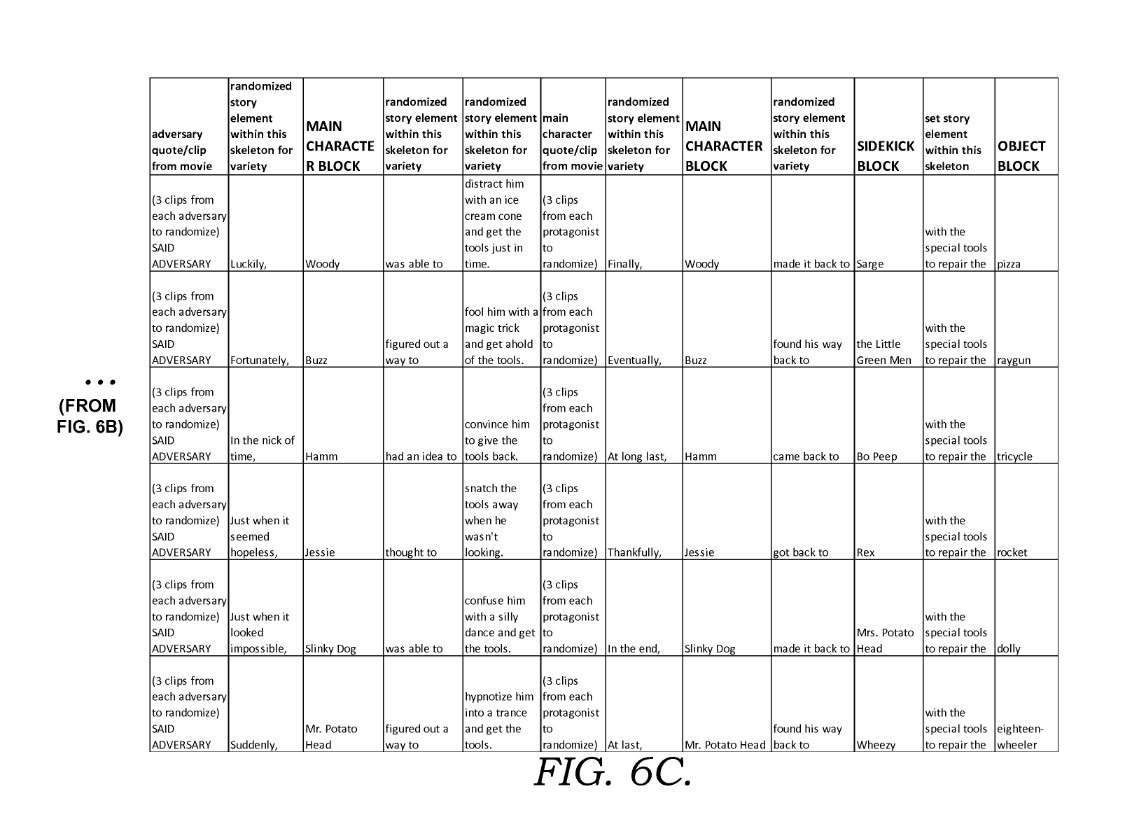

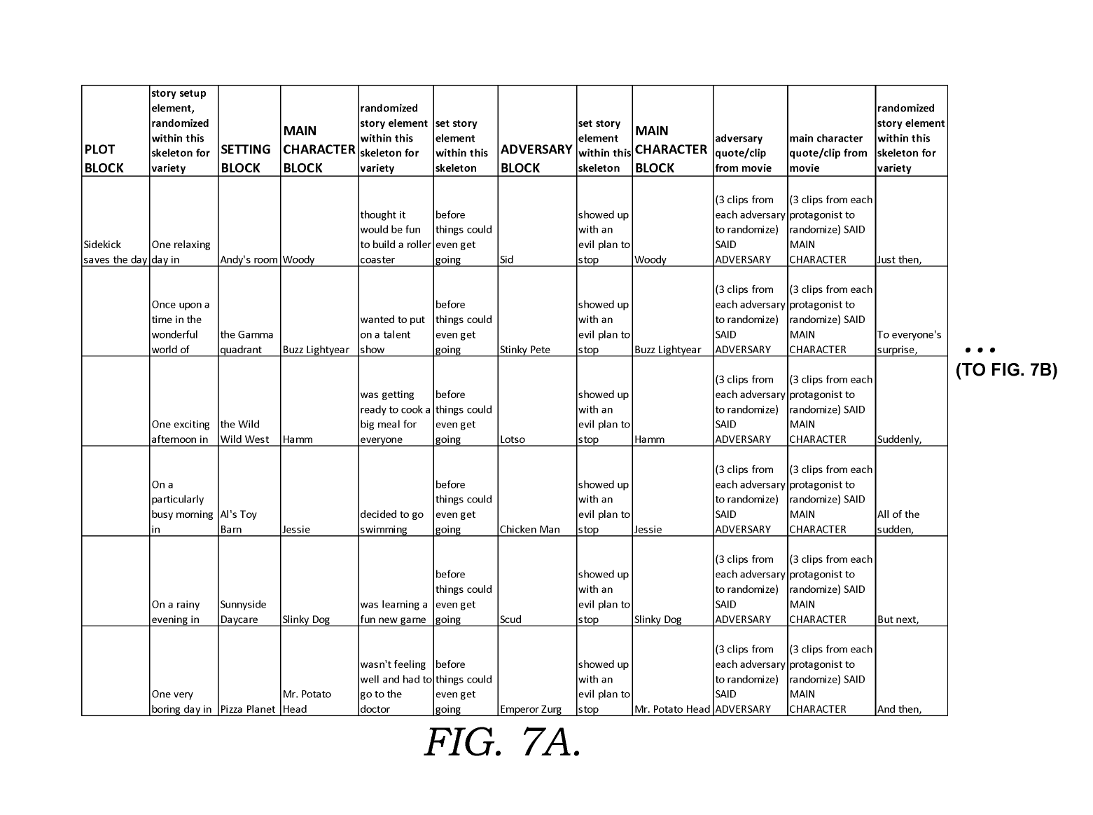

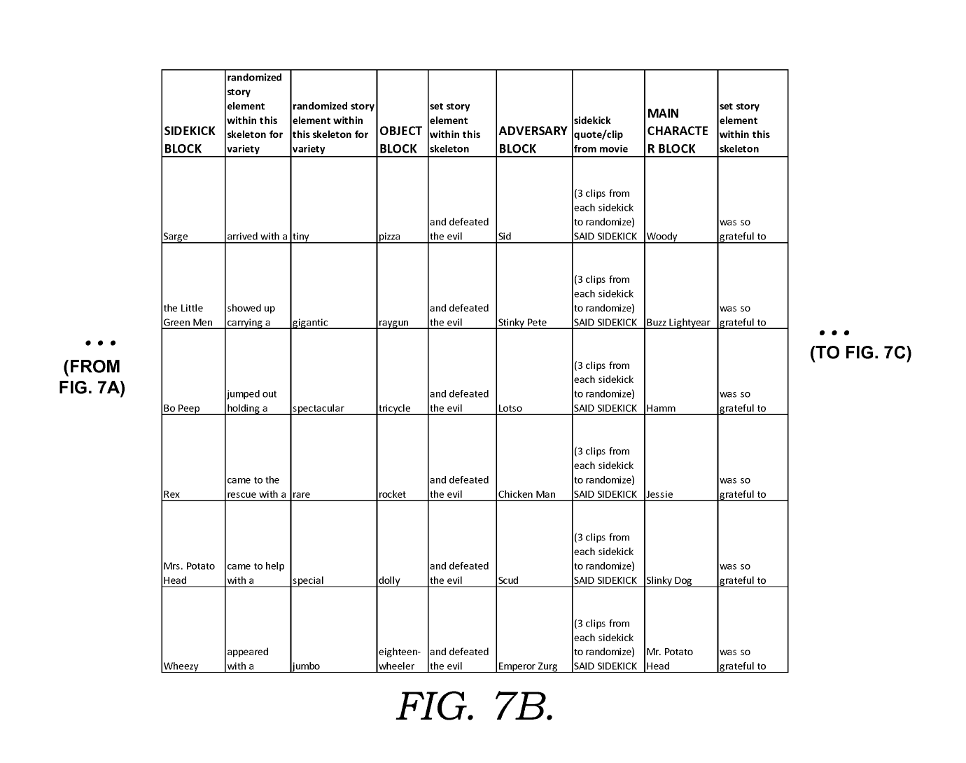

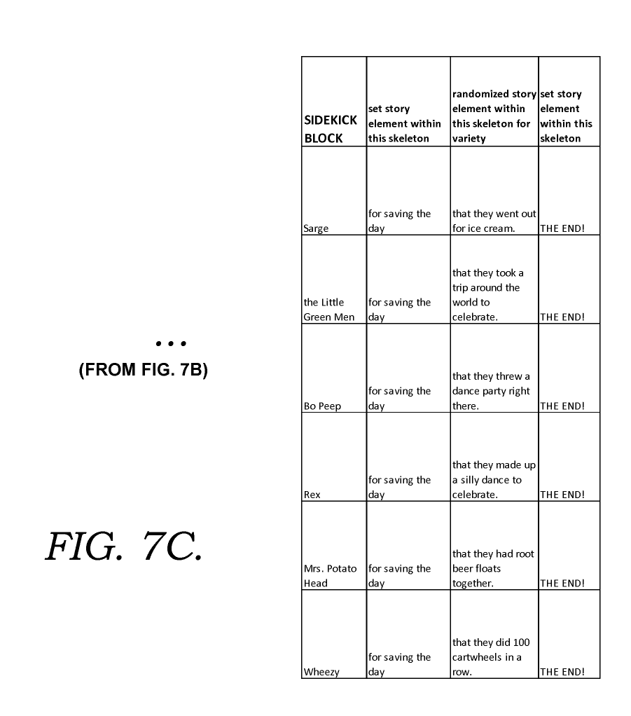

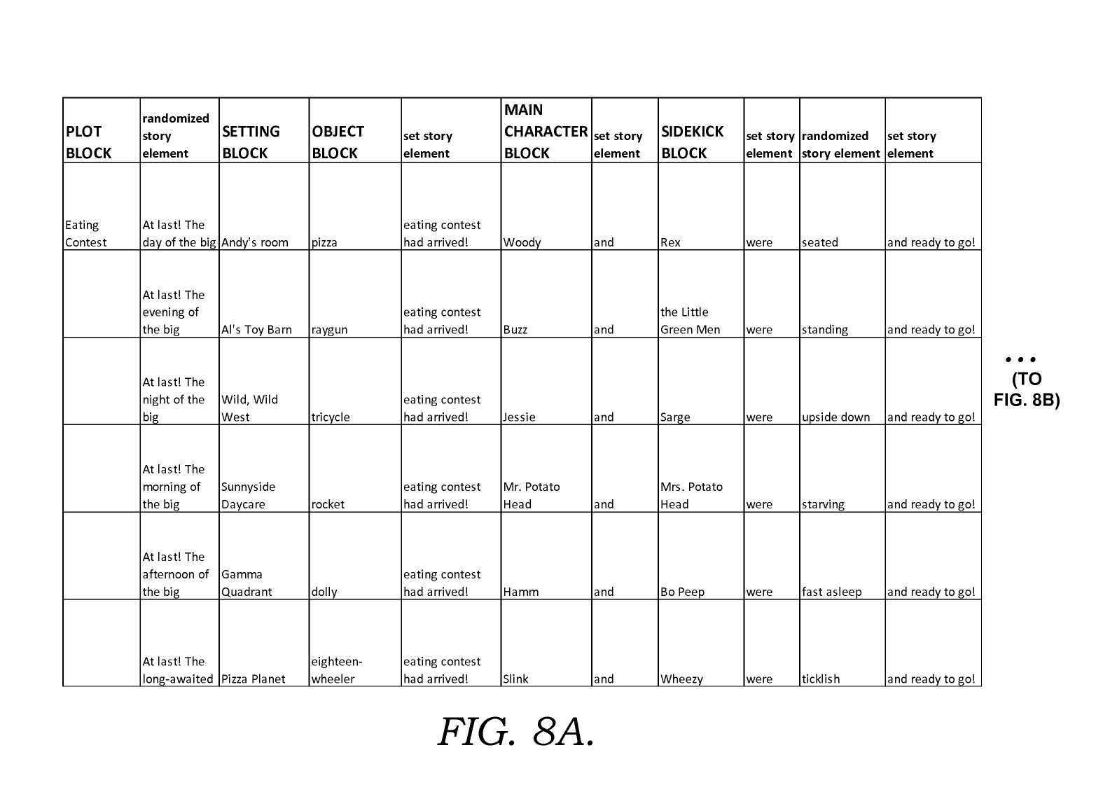

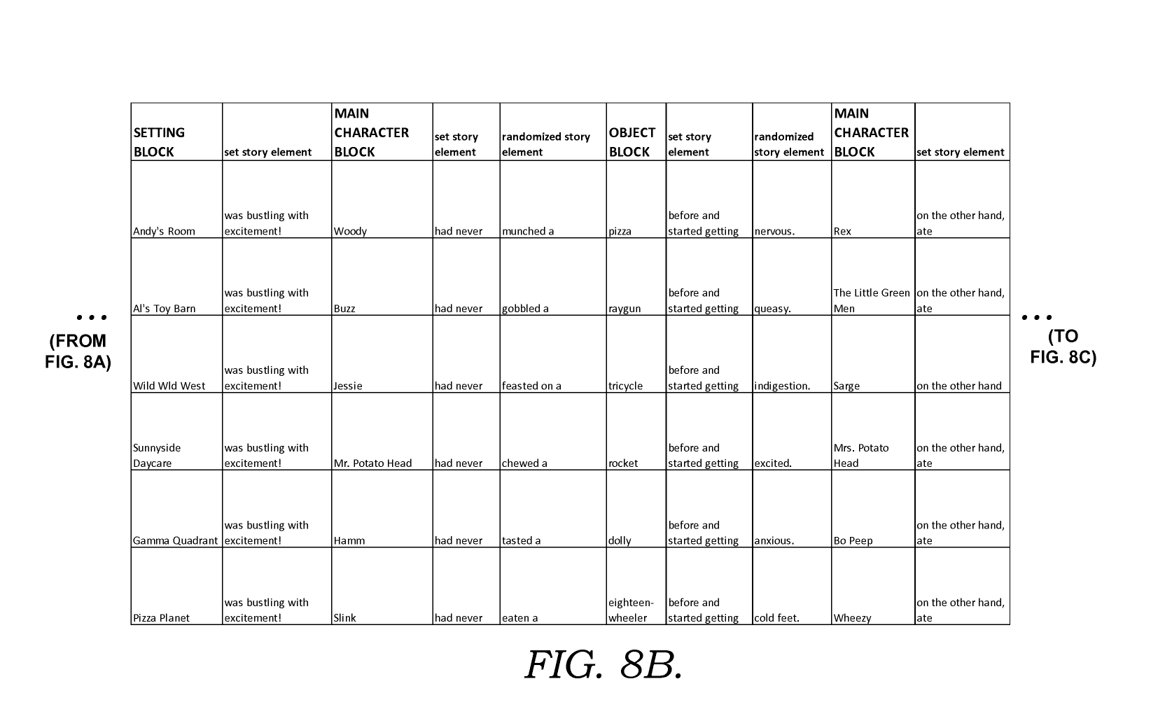

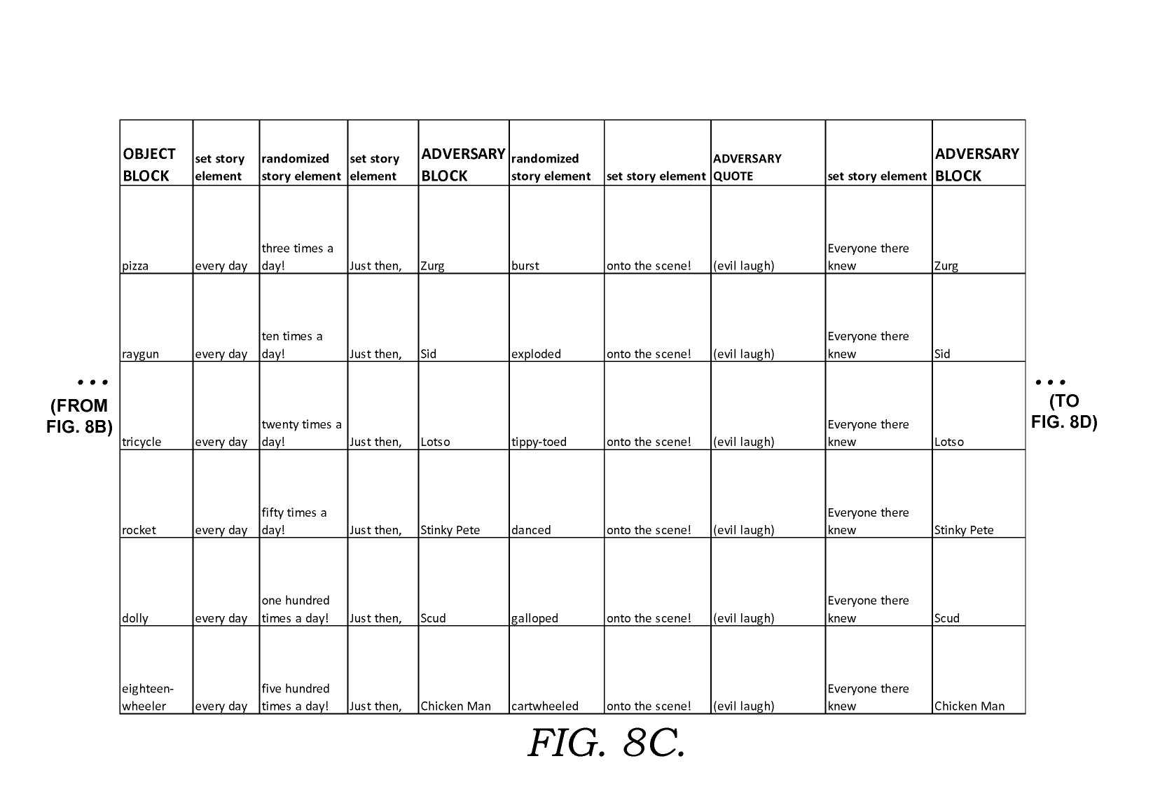

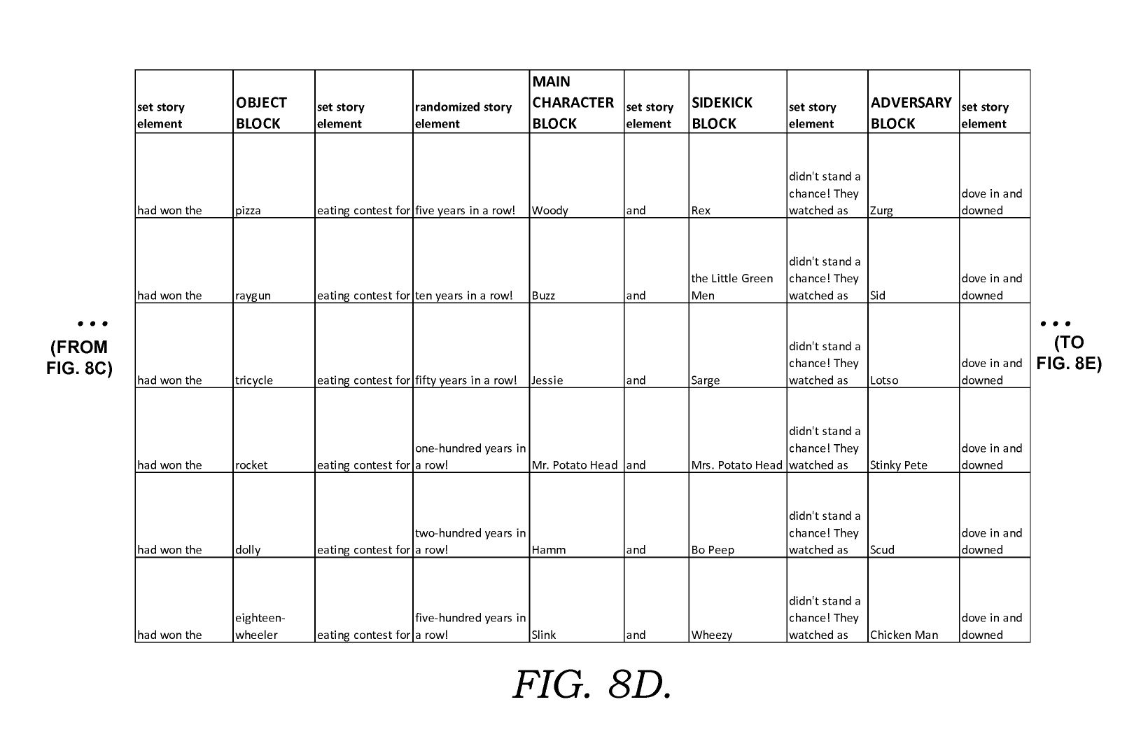

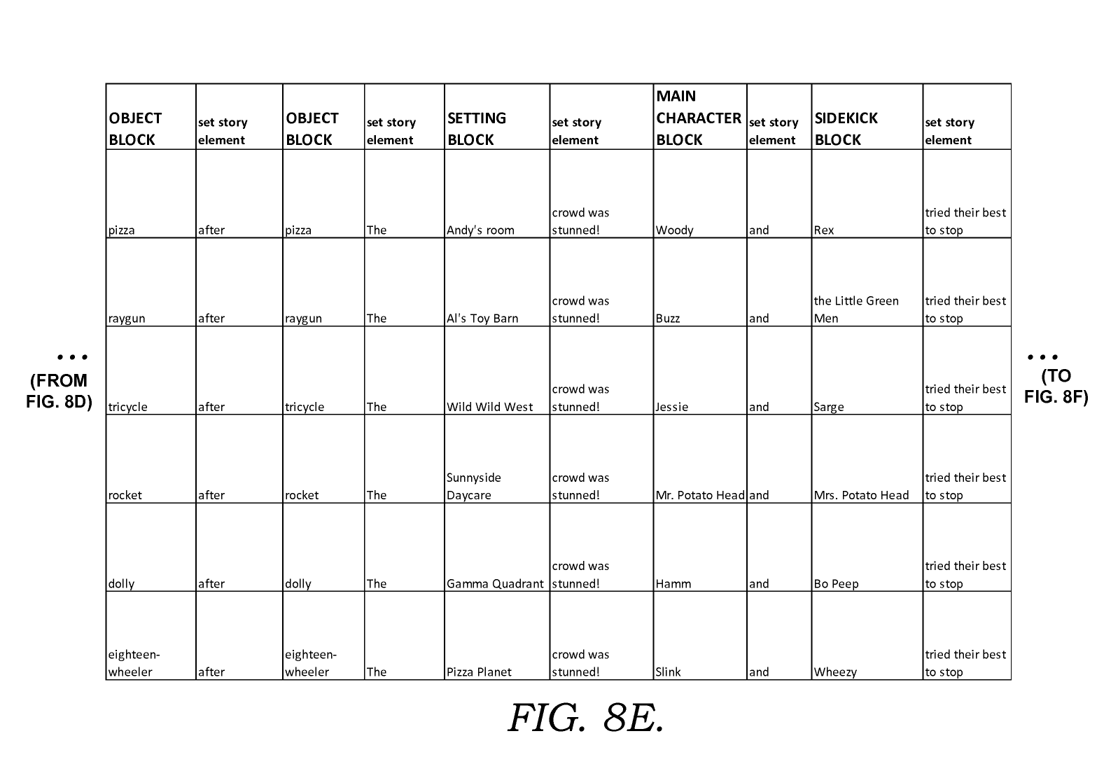

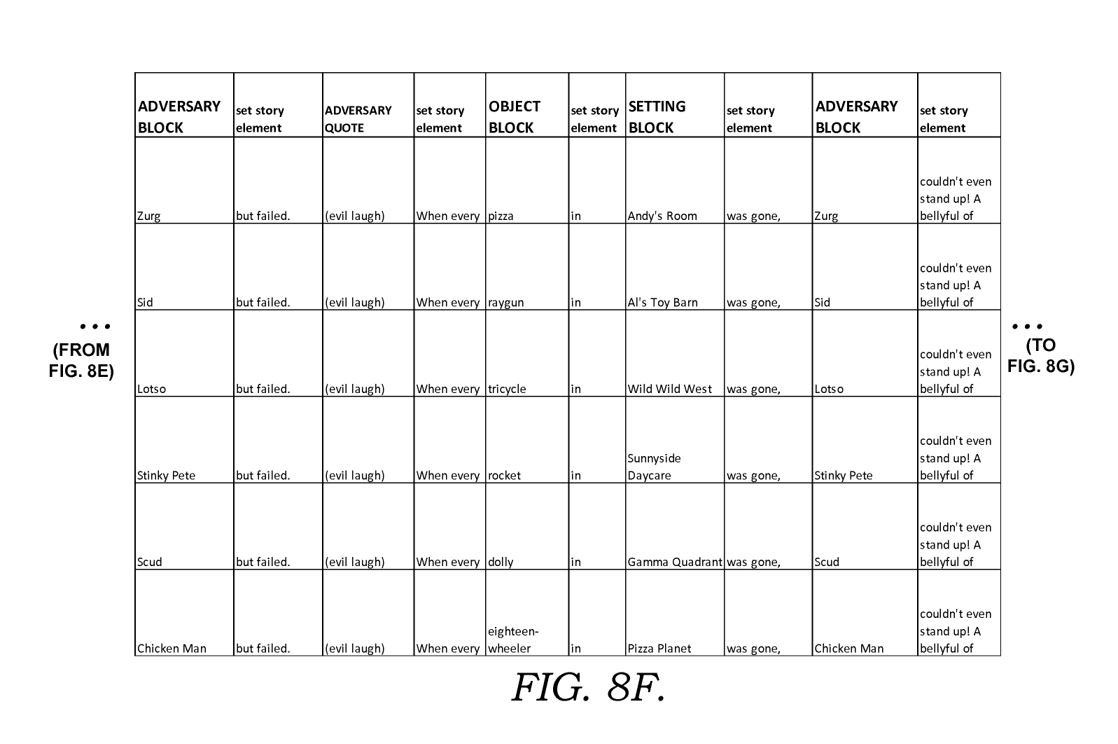

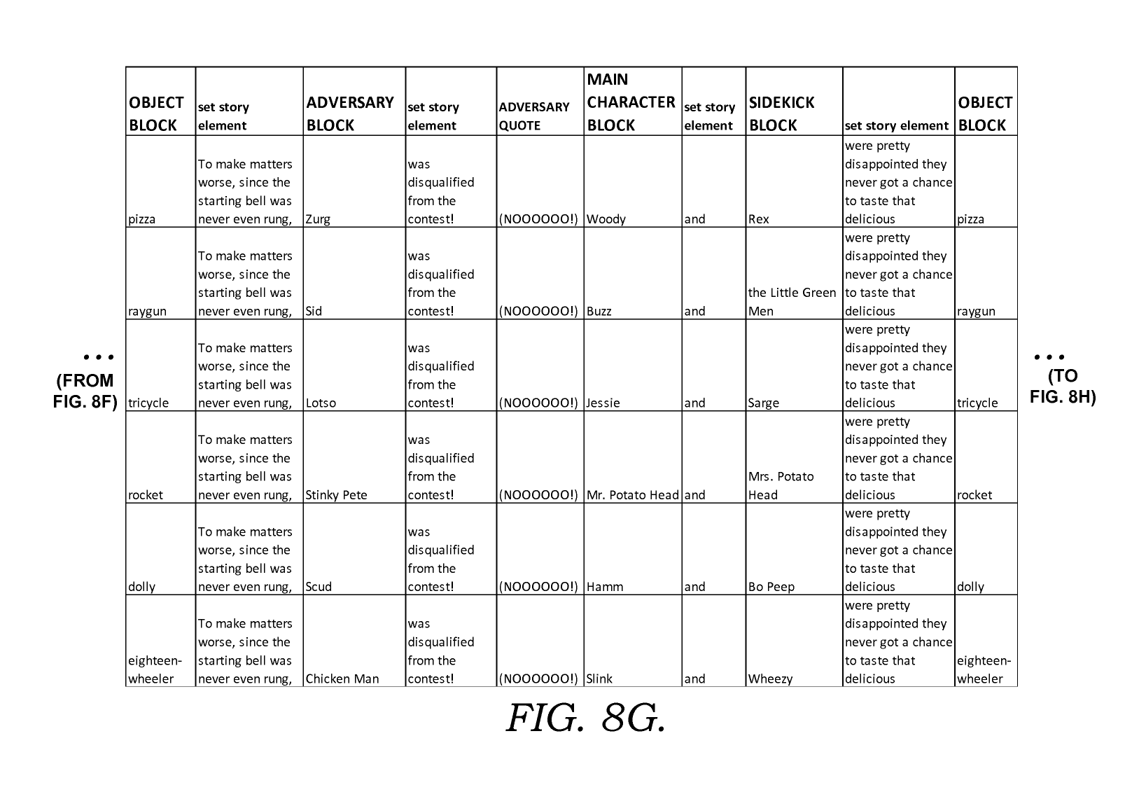

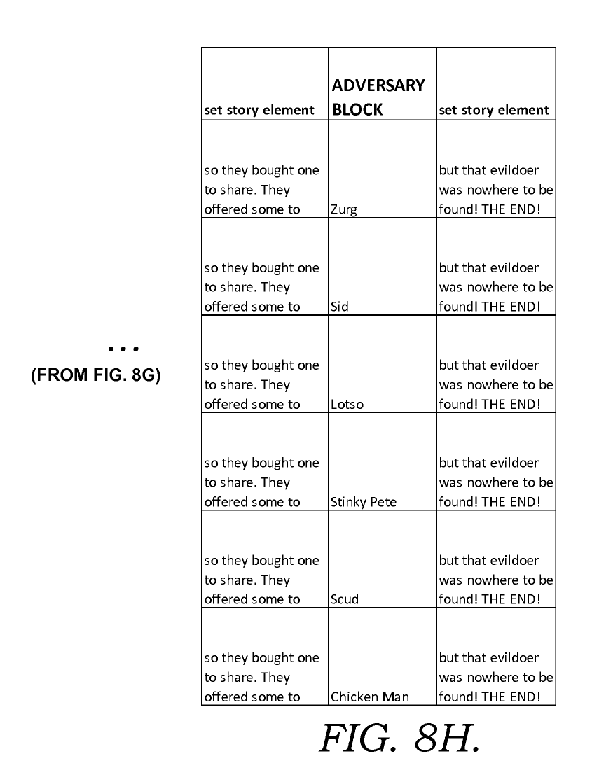

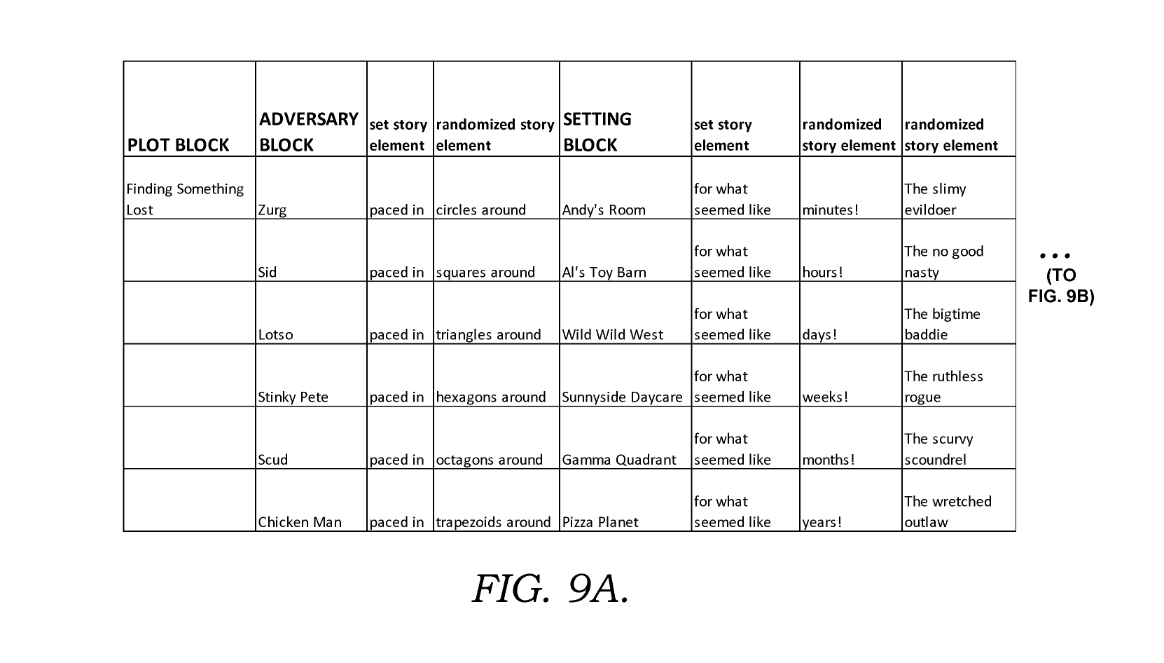

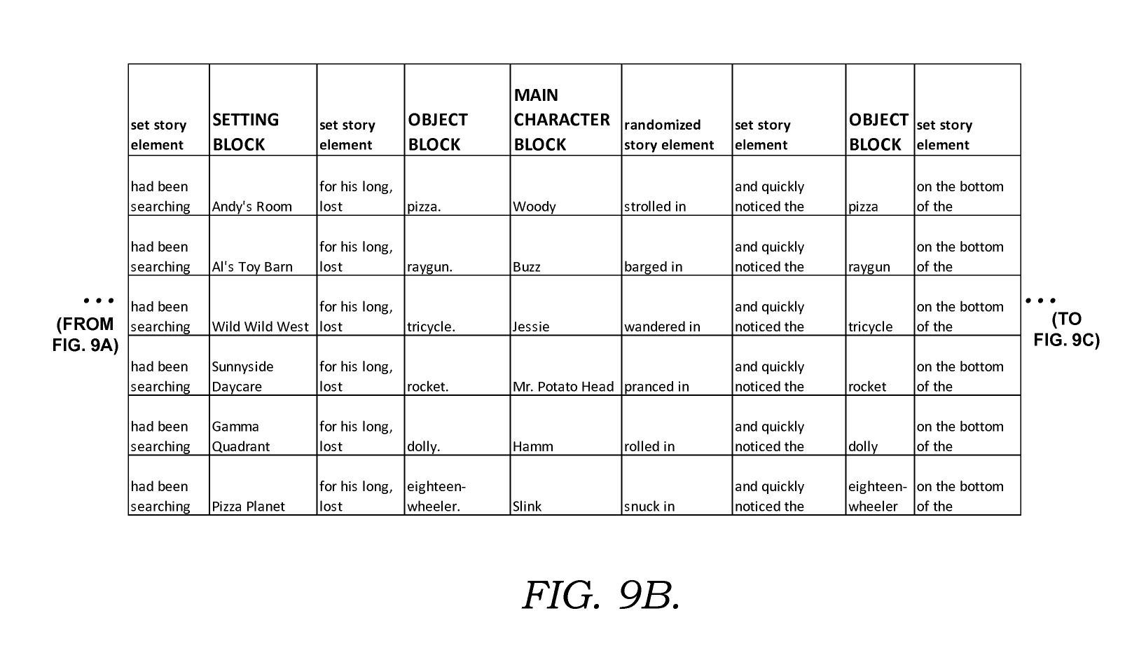

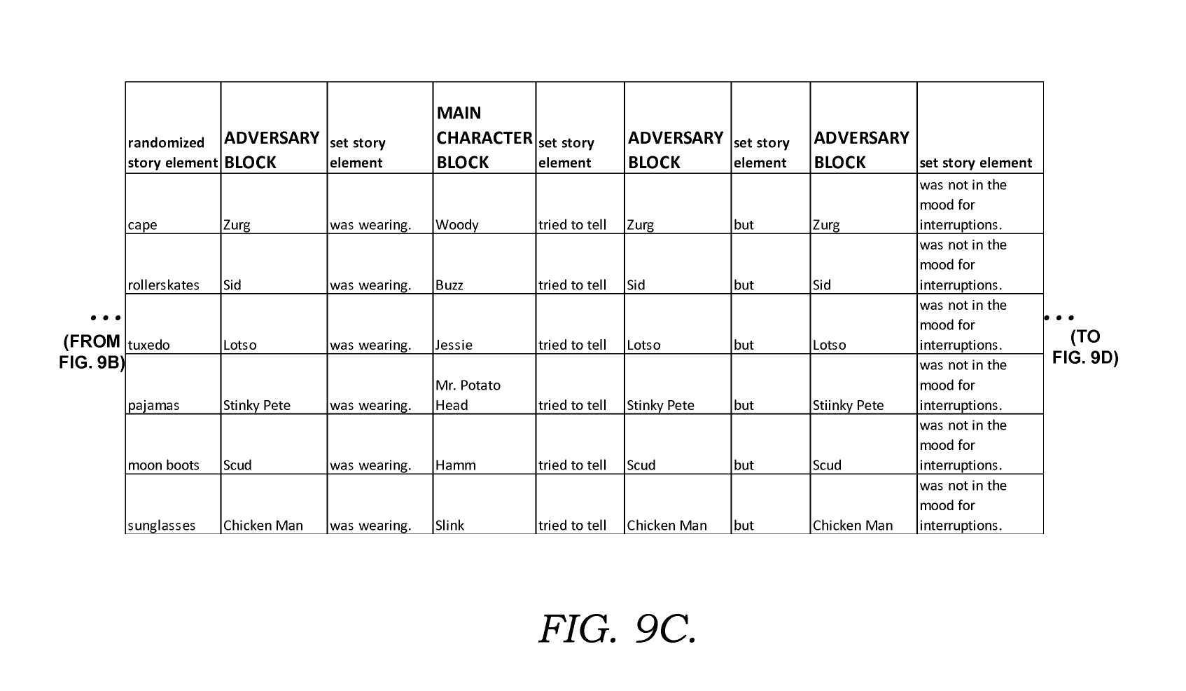

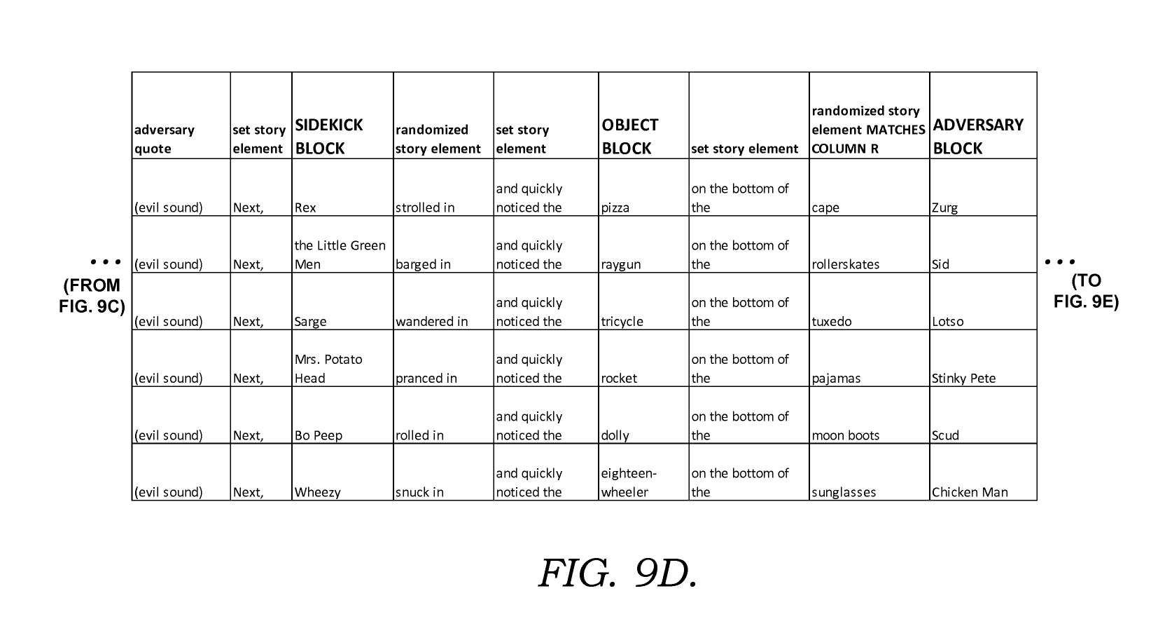

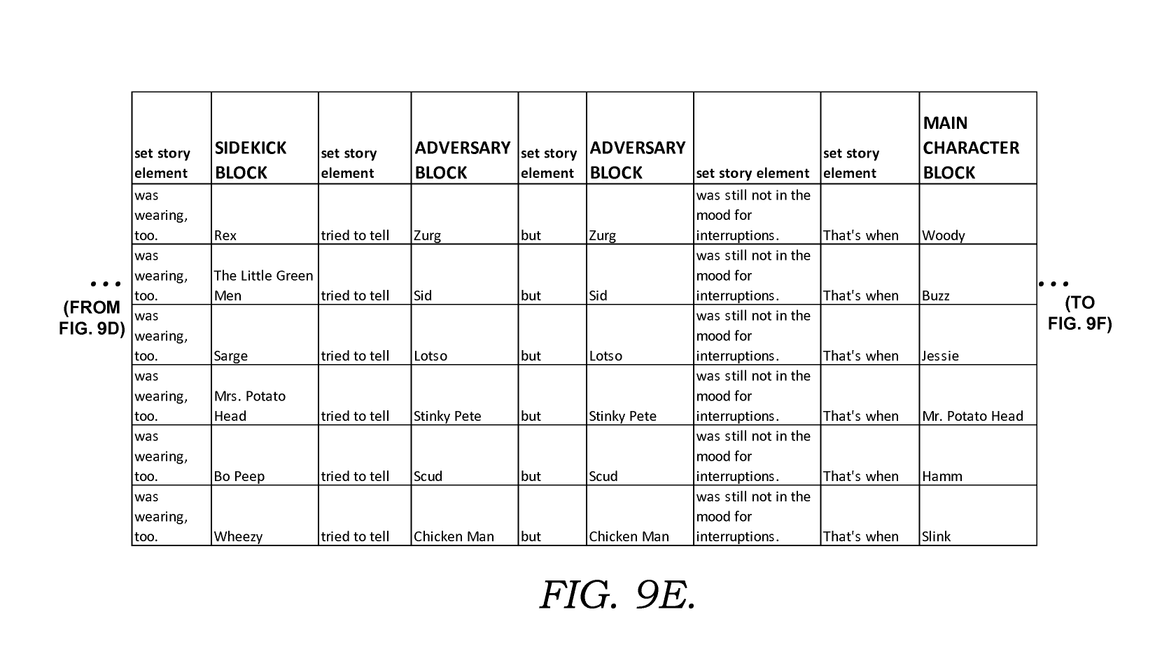

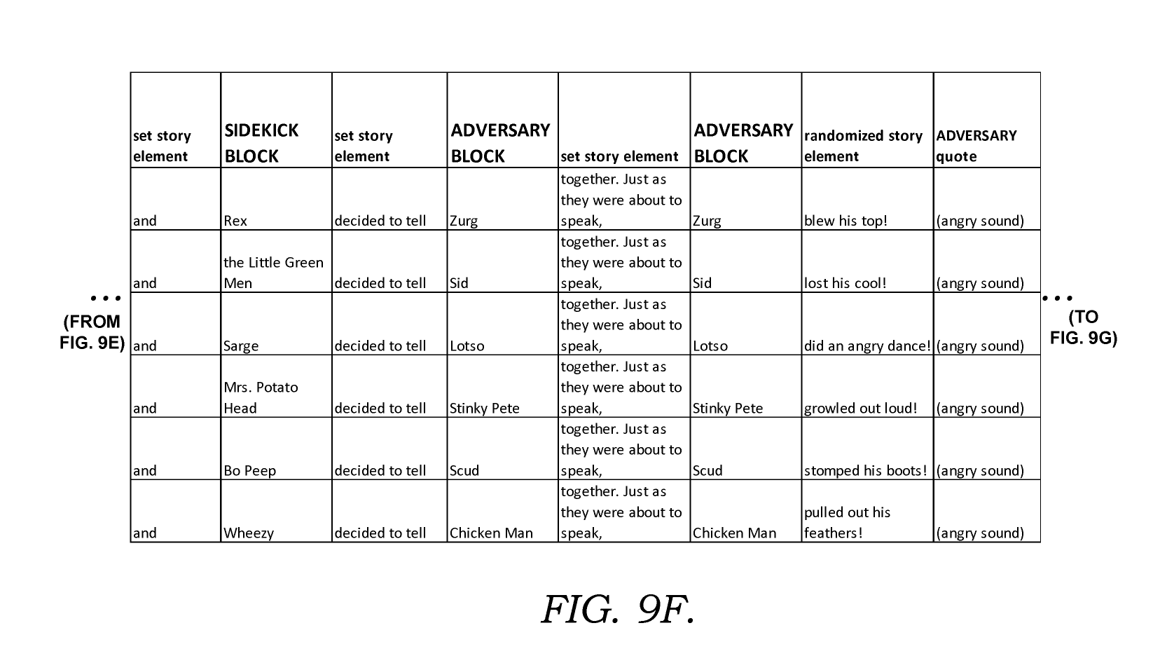

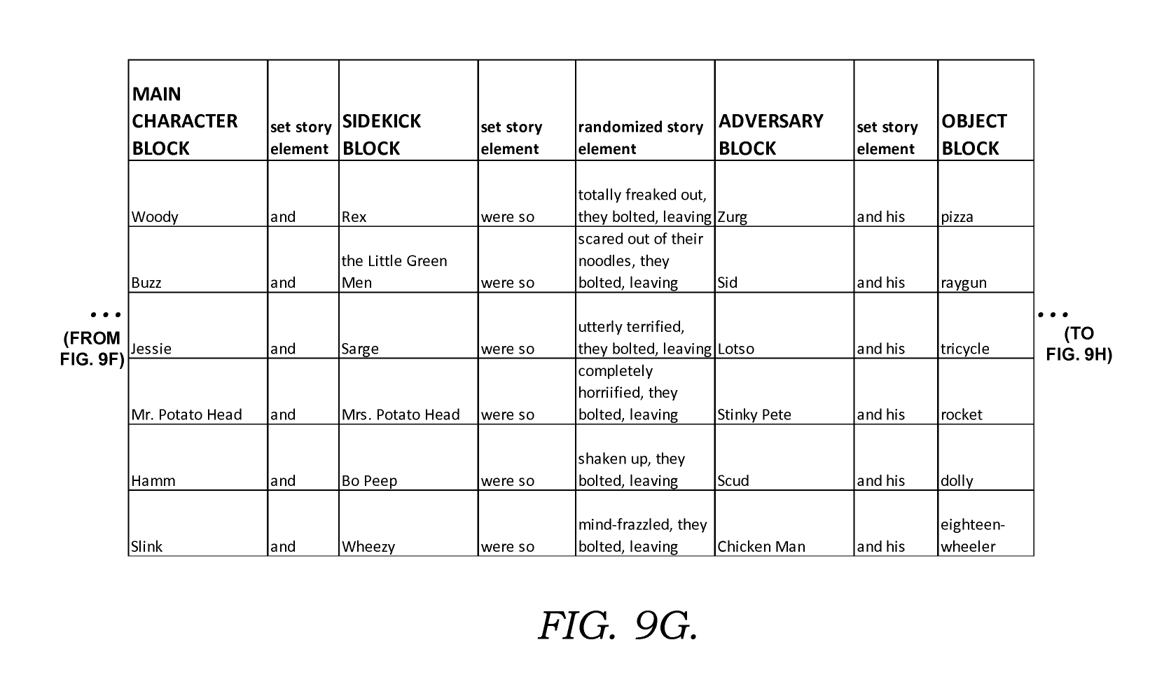

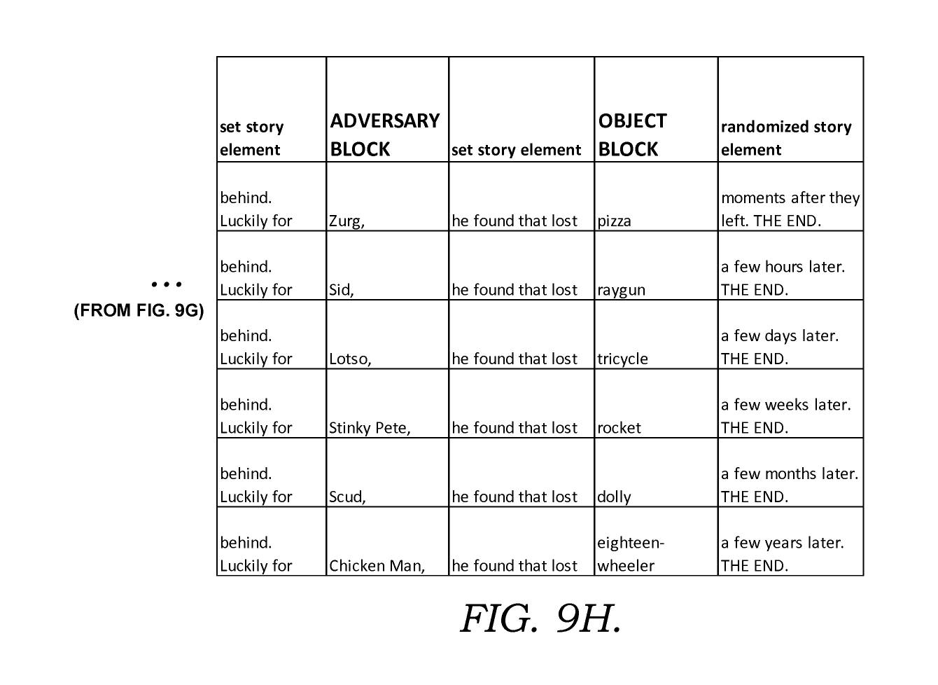

With reference to FIGS. 6A through 9H, four illustrative representations of portions of a story skeleton with example story-segments for assembling stories are provided. For purposes of illustration, portions of story skeletons are depicted in these figures as tables, wherein a column of the tables corresponds to a “slot” or place holder in the story to be “filled” or associated with a particular story segment or transition segment. The rows of the table provide specific segments which can be inserted or associated with the slot to make a story. Thus, a story may be logically assembled by moving along the table from left to right, specifying or determining a segment for each column, the segment determined based on logic (such as logic indicated in the heading of the column, logic determined based on previously determined segments (not shown) including determined transitioning segments for internal consistency, and/or based on the blocks (as indicated in the heading of some of the columns).

Turning now to FIGS. 10A-10C, an illustrative representation of an embodiment of a story skeleton or structure is depicted. In this example embodiment, the story skeleton comprises a series of one or more “slots” or placeholders for which story segments (including transitioning segments) can be associated or logically “inserted” in order to assemble a story. With reference to FIG. 10A, a story skeleton comprises a structure of ordered slots (e.g., Slots 1-Slot N), wherein the slots are illustratively indicated using < > symbols. In the example skeleton of FIG. 10A, each slot includes a particular story segment or transitioning segment based on the story elements specified by block information and logic. For example, slot 1 is associated with a segment that sets up the story, such as an opening narration, which might be embodied as an audio or video clip. Slot 2 is associated with a segment based on the main character, in this example.

With reference to FIG. 10B, an illustrative representation of a story assembly based on a representation of a story skeleton, such as described in FIG. 10A, is provided. The story skeleton of FIG. 10B comprises a sequence, series, or structure of ordered slots (or place holders) for associating with one or more story segments or transitioning segments. As described above in connection to FIG. 4 and FIGS. 6A-9H, in some embodiments, segments are determined based on logic specified by the story skeleton and/or based on block information. For example, in the example story skeleton of FIG. 10B, segments for the MAIN CHARACTER slot may be determined at least in part based on the block information specifying one of 6 main characters on the main character block (e.g., MAIN CHARs 1-6). Likewise, segments for the SETTING and OBJECT slots may also be determined based on block information.

In the example embodiment of FIG. 10B, segments for a SETUP SLOT comprise one of SETUP 1-SETUP N, and may be randomly (or pseudo-randomly) determined, determined based on block information (such as a plot block (not shown)), or based on other determined segments. Segments for SEGMENT SLOT 1 may be determined similarly. For example, a particular segment (e.g., SEGMENT 2 S1) may be determined randomly or based on a previously determined segment, such as SETUP 2 for SETUP SLOT. As discussed in connection with step 430 of method 400, in some embodiments, segments may specify slots, which may be associated with other segments or sub segments. For example, SEGMENT 3 includes SUB SEG SLOT 1, to be associated with one of SUB SEG 1-N segments, and a Main Character slot. Accordingly, in this example embodiment, a story may be assembled by logically connecting the segment(s) determined for each slot of the story skeleton. FIG. 10C depicts an illustrative representation of a portion of a “filled” story skeleton or story body. In some embodiments the story skeleton has a title, identity or identifier, such as STORY_ID, shown in FIG. 10C, and which may be used to specify a particular skeleton determined at step 420 of method 400, discussed in connection to FIG. 4.

In an embodiment, story data associated with story elements, such as the segments for the main character Woody, including sound effects, video clips, narrations about Woody, and other segments of Woody can include a set of transitioning segments associated with that element. By way of example and not limitation, the segment “and then Woody said” is a transitioning segment associated with the story element specifying the main character as Woody. For each story element (e.g., setting, character, object, plot, etc.) there exists a set of such transitioning segments associated with the element for use by the story skeleton logic for assembling a seamless story, in an embodiment. Further, in some embodiments, the transitioning segments include logic for which story elements or other segments they are compatible with or not compatible with. For example, transitioning segment 6, associated with Woody can be used in Plot 2 but not Plot 6.

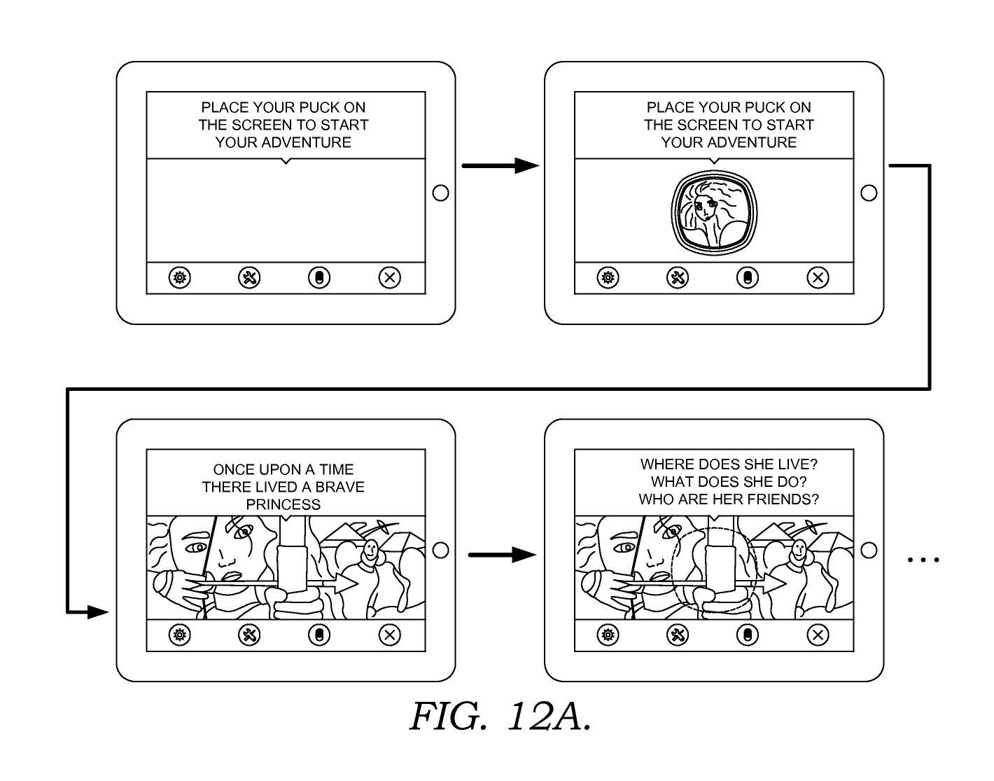

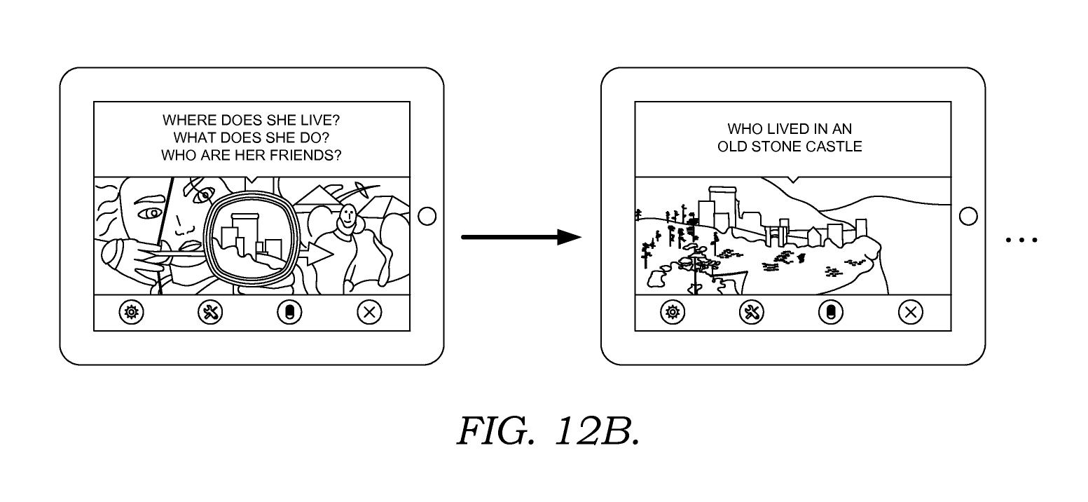

Turning to FIGS. 11A-12B, one example of a story-assembler comprising a tablet computing device running an app, and block-pucks is provided for assembling a story. In this example embodiment, blocks (pucks), as illustratively depicted in FIGS. 11A-B, are placed on a tablet surface to specify the story elements (e.g., characters, settings, plots, etc.). In some embodiments, the arrangement of blocks, such as described in connection to FIGS. 3A-3F, is determined by prompting the user, such as shown in FIGS. 11C and 12A. For example, upon placing a block of Princes Mireda, the story assembler app begins to tell a story, “Once upon a time there lived a brave princess.” The user is prompted for an additional story element, in the form of a questions such as “Where does she live?” “What does she do?” “Who are her friends?” With reference now to FIG. 12B, upon the user's placing on the surface a block showing a castle setting, the story assembler continues with the story “who lived in an old stone castle.” Although the example embodiment of FIG. 12A-B shows text for the story, as described previously it is contemplated by the inventors that audio or video corresponding to the text shown in FIGS. 12A-12B, including sound effects and images, may be played or further that text shown in FIGS. 12A-12B is not displayed.

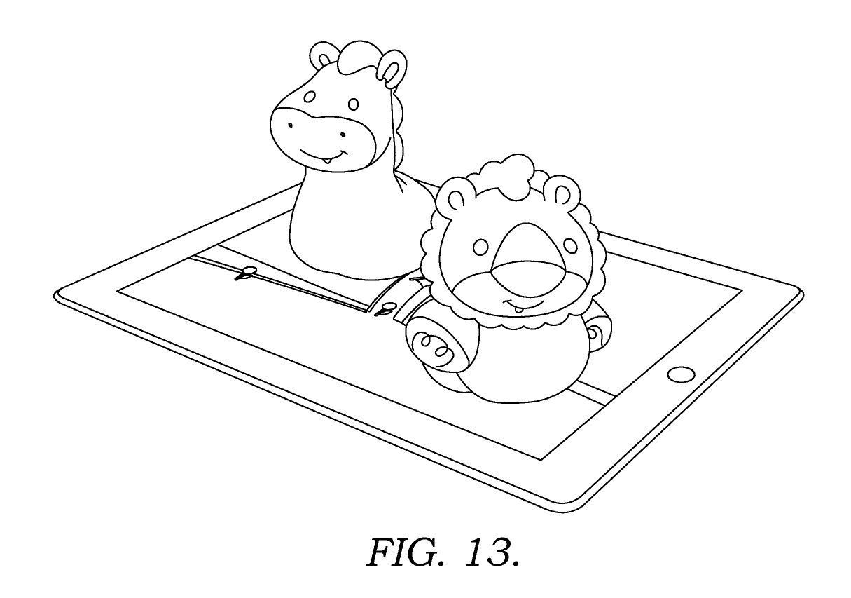

FIG. 13 illustratively depicts an example embodiment of a story-assembler including a tablet computing device and blocks embodied as toy characters (e.g., plush or stuffed animals).

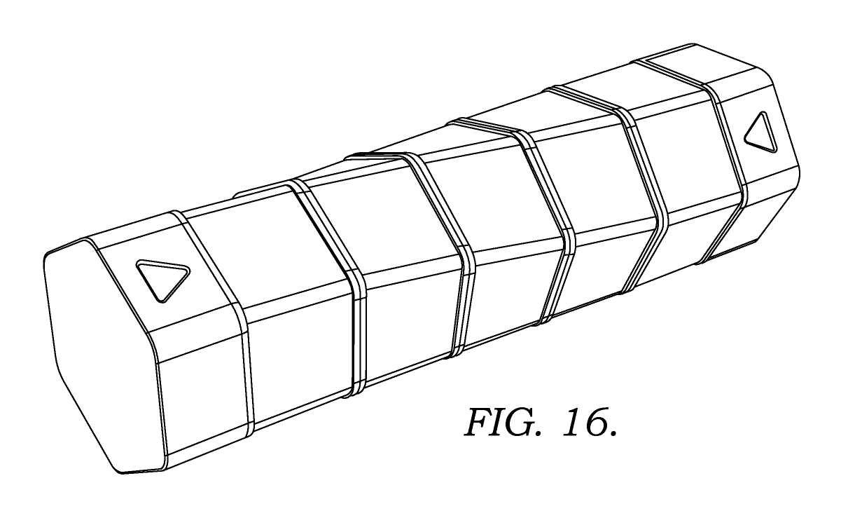

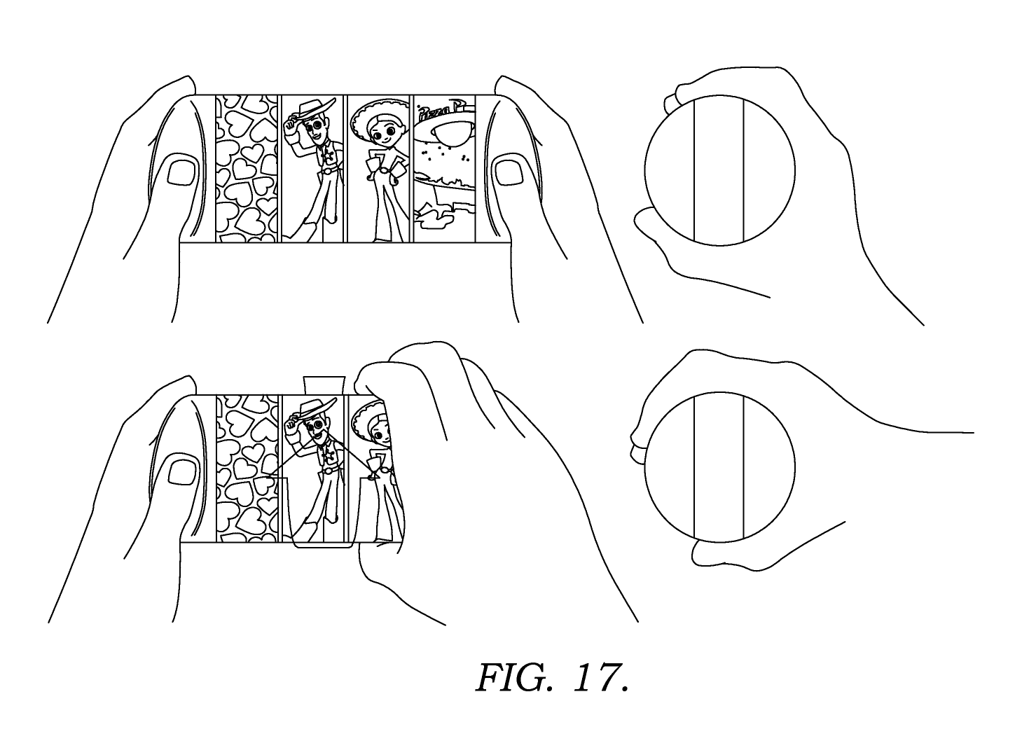

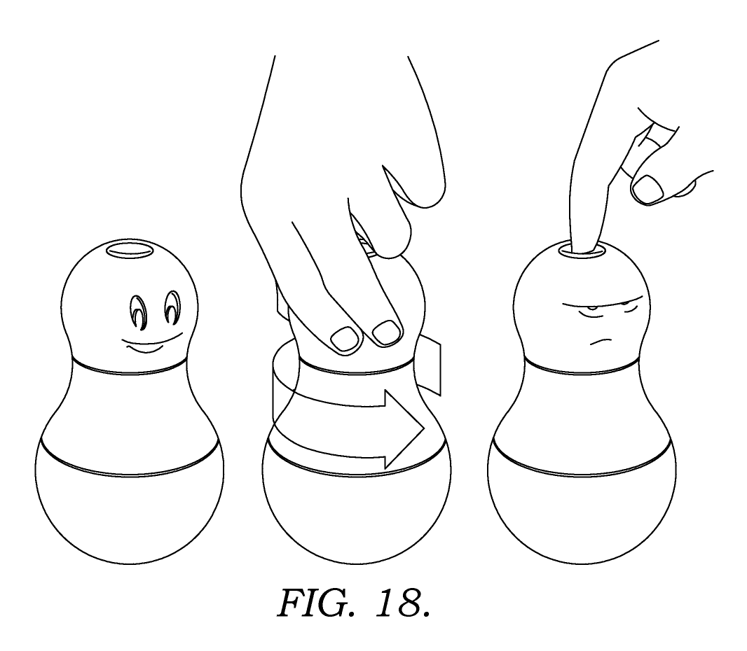

FIGS. 15-18 illustratively depict example embodiments of story-assembler devices in accordance with embodiments of the present invention, wherein “blocks” are arranged by physically manipulating the assembler devices (FIGS. 16-18) or inserting or arranging cards (“blocks”) into the story assembler (FIG. 15). For example, the assembler device shown in FIG. 16 includes rotatably connected six-sided segment-components (“blocks”), wherein each segment-component can be rotated into a different position. In this example, arrows on each end of the device indicate the selected (arranged) face of the segment-component. Similarly, the example story assembler device of FIG. 17 includes rotatable segment components (“blocks”), which can be manipulated by a user in order to specify story elements, based on the displayed images (analogous to arranging blocks, as described in connection to FIGS. 3A-3F). Finally, FIG. 18 depicts an embodiment of the story assembler in the form of a character, wherein a user rotates or manipulates portions of the character to specify story elements. For example, the head of the character is rotated to indicate whether the character is happy or angry. (In other similar embodiments, the head or torso may be rotated to select characters or objects, which may be depicted as being held in the character's hand, in the torso.) The example story assembler embodied in FIG. 18 includes a button on the top of the character's head for playing back the assembled story.

Many variations can be made to the illustrated embodiments of the present invention without departing from the scope of the present invention. Such modifications are within the scope of the present invention. For example, although depicted as resembling a book in one embodiment, the story assembler may take on other forms, such as illustratively described in FIGS. 11A-18. As another example, in one embodiment using virtual blocks, a story assembler app prompts the user for all story-element information needed to assemble the story. In some such embodiments, the blocks need not be shown, and instead are merely logical data containers from which the assembler determined information about the story elements. In an alternate embodiment, the blocks may be graphical representations of blocks displayed by the story assembler app and users may rotate the virtual blocks by moving their finger across the touch screen surface of the tablet computing device.

From the foregoing it will be seen that this invention is one well adapted to attain all ends and objects hereinabove set forth together with the other advantages, which are clear following the complete disclosure above and which are inherent to the methods and apparatuses described herein. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

The invention claimed is:

1. A story assembler comprising:
a set of story blocks, each block having at least one block-identifier corresponding to one or more story elements;
a story-block identification component for determining story-block information based on a block identifier;
a user interface; and
a computing device, comprising one or more processors and memory, for generating a story based on story-block information and providing the generated story to the user interface.

2. The story assembler of claim 1, wherein the story-block identification component determines story-block information based on a physical or virtual arrangement of the set of story blocks.

3. The story assembler of claim 2 wherein each story block in the set of story blocks comprises one or more visual cues corresponding to the one or more story elements, each visual cue comprising an image or pattern representing one story element, wherein the physical or virtual arrangement of the set of story-blocks corresponds to a set of story elements, and wherein the computing device uses the story-block information to determine the set of story elements, and generates the story to include the set of story elements.

4. The story assembler of claim 2, wherein the story-block information is determined based on the position and orientation of each story block in the set of story blocks, and wherein the story block information comprises information corresponding to the block identifier.

5. The story assembler of claim 1 further comprising a block-receptacle component for holding the set of story blocks, and wherein the story-block identification component is configured to determine the story-block information based further on an arrangement of the set of story blocks in the block-receptacle component.

6. The story assembler of claim 1 wherein the block identifier comprises an identifying image, pattern, color, virtual or printed code, texture, weight, RFID, electrical or magnetic characteristic, weight, size, or shape, and wherein each block in the set of blocks comprises a cube, puck, disk, card, icon, or toy character.

7. The story assembler of claim 1, wherein the story generated by the computing device is internally consistent, and where each story element of the one or more story elements comprises a protagonist, setting, plot, adversary, object, or sidekick-character element of a story.

8. The story assembler of claim 1, wherein the computing device generates the story by executing on the one or more processors computer-executable instructions stored in the memory, that cause a method to be performed for assembling a story, the method comprising:
determining story-block information from the story-block identification component;
based on the determined story-block information, determining a story skeleton;
based on the determined story skeleton, determining one or more story segments;
determining one or more transitioning segments based on the determined story segments; and
logically assembling the story segments and transitioning segments into an order.

9. The story assembler of claim 8, wherein the story skeleton comprises a logical sequence of story slots and logic for determining one or more specific story segments and transition segments to be associated with each story slot.

10. The story assembler of claim 8, wherein each story segment comprises at least one of a story narration, sound effect, character expression or images, plot development, text, audio, or video media and wherein a transition segment comprises a story narration, sound effect, character expression or images, plot development, text, audio, or video media for providing a transition between two story segments that renders the story internally consistent.

11. The story assembler of claim 1, wherein the generated story comprises audio or video content provided by a user.

12. One or more computer-readable storage devices having computer-executable instructions embodied thereon that when executed, facilitate a method for generating a story comprising:
determining first story-block information based on a first arrangement of a set of story blocks;
based on the determined first story-block information, determining a first story skeleton;
based on the determined first story skeleton, generating a first set of story segments;
determining a first set of transitioning segments, based on the generated first set of story segments; and
generating a first story based on the first story skeleton, first set of story segments, and first set of transition segments.

13. The one or more computer-readable storage devices 12, wherein determining the first story skeleton comprises determining a set of story skeletons corresponding to the first story-block information, and determining a specific first story skeleton from the set of story skeletons, wherein the specific first story skeleton is determined based at least in part on the story skeleton of set of story skeletons that was last used for generating a story.

14. The one or more computer-readable storage devices 12, wherein the first set of story segments are generated pseudo randomly, and wherein the first set of transitioning segments is determined such that the first story is generated to be internally consistent.

15. The one or more computer-readable storage devices 12, wherein the first story skeleton comprises a logical sequence of story slots and logic for determining one or more specific story segments and transition segments to be associated with each story slot; wherein each story segment comprises at least one of a story narration, sound effect, character expression or images, plot development, text, audio, or video media; and wherein each story block in the set of story blocks comprises a cube, puck, disk, card, icon, or toy character.

16. The one or more computer-readable storage devices 12, wherein generating the first story comprises logically assembling the first set of story segments and first set of transitioning segments into an order based on the first story skeleton.

17. The one or more computer-readable storage devices 12, wherein a second arrangement of the set of blocks that is different than the first arrangement, will cause the method to generate a second story that is different than the first story.

18. A method for generating a story comprising:
receiving a selection of story attributes defined by an arrangement of story blocks;
generating a story structure based on the selection of story attributes;
determining a set of story segments and transitioning segments based on the story structure or the received selection of story attributes;
logically assembling the story segments and transitioning segments into an order based on the story structure; and
generating a story based on the logical assembly of story segments and transitioning segments,
wherein each story block comprises a cube, puck, disk, card, icon, or toy character, and wherein the generated story includes the selection of story attributes.

19. The method of claim 18, wherein each story segment comprises at least one of an audio or video media clip; wherein each transition segment comprises an audio or video clip for providing a transition between two story segments such that internal consistency is provided among story elements of the story.

20. The method of claim 18, wherein the story structure comprises a logical sequence of story slots and logic for determining one or more specific story segments and transition segments to be associated with each story slot; and wherein each story attribute comprises a protagonist, setting, plot, adversary, object, or sidekick-character, or other element of a story.
